(19) United States
(12) Patent Application Publication
(10) Pub. No.: US 2003/0009600 A1
(43) Pub. Date: Jan. 9, 2003

(54) Program execution service providing system, server program execution service providing method and storage medium storing program therefor

(75) Inventors: Kazuya Koyama, Tokyo (JP); Nobuyuki Tomizawa, Tokyo (JP)

Correspondence Address: FOLEY AND LARDNER, SUITE 500, 3000 K STREET NW, WASHINGTON, DC, 20007, US

(73) Assignee: NEC CORPORATION

(21) Appl. No.: 10/115,125

(22) Filed: Apr. 4, 2002

(30) Foreign Application Priority Data
Apr. 5, 2001 (JP) 2001-106577

(51) Int. Cl. G06F 9/00; G06F 9/54; G06F 15/163; G06F 9/46

(52) U.S. Cl. 709/310; 709/312

(57) ABSTRACT

A program execution service providing system can realize a system receiving specialized service adapted for request of each of users of services. The program execution service providing system includes a client connecting mechanism connecting a client to a server via a network, a program management mechanism reading program uploaded by the client and a program preliminarily prepared in the server, a program verification and conversion mechanism verifying that the read program satisfies security not affecting for the server or other program and converting adapting for execution by the server as required, a program execution control mechanism controlling for executing a program converted and managing the calculation resource to be used fairly among actuated programs, inter-program communication mechanism for mutual communication of a plurality of read programs and external device communication mechanism cooperating the program read by the program management mechanism and an external system of the server.

### BACKGROUND OF THE INVENTION

1. Field of the Invention

The present invention relates generally to a program execution service providing system, a server, a program execution service providing method and a storage medium storing programs therefor. More particularly, the invention relates to a program execution service providing system executable of process desired by a user on a common server.

2. Description of the Related Art

In the recent years, various useful information and services are provided on a network. Particularly, huge number of services is currently provided in onerous or free by various business enterprises, organizations, individuals and so forth on World Wide Web (WWW). Many of those are premised in use of browser to permit receiving of service by direct operation by users.

However, services basically provided on the network available for the users are those prepared by service providers. Therefore, it is not always possible to use services desired by the users.

For example, in a technology disclosed in Japanese Unexamined Patent Publication No. Heisei 11 (1999)-345202, there has been proposed a method for varying services to be provided depending upon skill of the users. This is mere selection of preliminarily prepared services adapting to the users and is not make services which are not preliminarily prepared, available.

On the other hand, in a technology disclosed in Japanese Unexamined Patent Publication No. Heisei 10 (1998)-260821, there has been proposed a method to permit users to select information contents to receive as services. However, even in this case, items available for selection are those preliminarily prepared by the service provider and services other than those preliminarily prepared by the service provider are not available at all.

As a solution for inconvenience as set forth above, there has been proposed a method for customizing of services as requested by the user or a method for up loading programs realizing requested services on a server.

For example, in a technology disclosed in Japanese Unexamined Patent Publication No. 2000-47912, there has been proposed a method of automatically generating a program for monitoring a log to transfer to the server. On the other hand, in a technology disclosed in Japanese Unexamined Patent Publication No. 2000-155743, there has been proposed a method for generating an agent for performing process of an event, in which an agent definition is transferred from a client to the server and the agent is generated in the server.

However, these systems are limited to available function in monitoring and event processing and are not adapted for all of variety of services. On the other hand, since use by general public has not been considered, resource management function of the server has not been provided to cause make it impossible to prevent improper occupation of CPU (central processing unit) or memory resource of the server by evil user, bug in the program or other causes and to prevent improper or illegal process and so forth.

Furthermore, some of the service desired by the user cannot be satisfied by one time of service execution and require continue certain process for a given period. One example of such service is monitoring of variation of transaction price in the stock market, automatic transaction and so forth. However, general user is difficult to establish connection to the service through an always-on network for the reason of communication circuit, terminal or the like, to perform process. Therefore, there is a method to enable to provide service for standing in continuous process.

For example, in U.S. Pat. No. 5,974,406, there has been proposed a system, in which the user issues a certain monitoring request to the server to shut-down connection, subsequently, the server stands in monitoring process to send a notice to the user through an appropriate means when a given condition is satisfied. On the other hand, even in a technology disclosed Japanese Unexamined Patent Publication No. 2000-155743, execution of monitoring process by server is enabled.

However, in these systems, object of continuing process is limited to the monitoring process, and is difficult to apply processes other than monitoring. For example, upon performing not only monitoring of stock but also automatic transaction, necessary information required depending upon each individual process content, such as current shareholding, cash balance, trading history and so forth. However, in the foregoing existing technology, a function for holding such information has not been provided. In case of monitoring process, as long as monitoring algorithm is provided, executing condition information or the like for other process is not required. However, in typical continuous process as we as automatic transaction, it becomes necessary to hold executing condition of the process.

As means for realizing holding of the executing condition, it becomes possible to hold the executing condition of single process by holding executing condition in the program per se. However, in this system, when the process includes interaction with the executing, condition of process executed outside of the server or other process, it is not possible to store the executing condition together with the condition of the counterpart of the interaction without discrepancy.

For example, when a process to perform ordering of stock sends an order sheet to a security company outside of the server, unless the process for sending the order sheet and storing of executing condition is controlled to certainly executed sending of the order sheet and storing of the executing condition of the single process simultaneously, erroneous understanding is caused that the order sheet has not been sent in the process to cause doubling of order if the executing condition is not stored due to system failure or other cause in spite of the fact that the order sheet has been sent and system is re-booted. For avoiding such condition, it is required to cooperatively perform the communication process and storing of the executing condition. However, the system, in which the own executing condition is stored by the processing program per se, cannot realize this.

On the other hand, while different from server operation through browser, as a technology for performing process desired by the user on other computer, there is a technology called as mobile agent. For example, in technologies disclosed in Japanese Unexamined Patent Publication No. Heisei 7 (1995)-182174 or Japanese Unexamined Patent Publication No. 2000-20487 and so forth, an object to be called as agent generated on certain computer and its definition program are moved to other computer designated by issuance of moving command with maintaining executing condition to enable continuation of execution of the process. Using this, an agent is generated in the terminal owned by the user and then is transferred to the server to execute the service to enable arbitrary service on the server.

However, in these mobile agent technologies, there has not been provided a function for execution management by uploading only program from a remote client to the server. As a result, upon operating the server from the remote client to execute the desired process, it is inherent to activate the program on the side of the client and after activation, the activated program is moved to the server.

In contrast to this, since dedicated execution environment has to be installed on both of the computers on the side from which the agent is moved and the side, to which the agent is moved, in the mobile agent, the user has to prepare these dedicated execution environments on the own terminal. On the other hand, moving process of the agent has to be performed by sending both of the object and the definition program at every occasion to make communication amount between the terminal and the server required for moving large.

Furthermore, such mobile agent technology encounters a problem to cause difficulty in assuring security in both of the server and agent (M. S. Greenberg, J. C. Byington and D. G. Harper, “Mobile Agents and Security”, IEEE Communications Magazine, pp 76 to 85, July, 1998). Therefore, such mobile agent technology is difficult to use in actual system.

On the other hand, in loading of the system to transferring and executing the program between different computers, such as uploading/downloading of the mobile agent or program and so forth, languages [such as Java (registered trademark of Sun Microsystems Inc. U.S.A.)] of an interpreter system (a system for executing necessary minimum source programs at every occasion) as one of execution types of the programs described by high level programming language, have been used widely.

In such system, not only the program to be transferred, but also the program per se controlling execution of the transferred program is frequently described by Java language. The reason of such construction is that the program to be transferred can be described not relying on the architecture, and that the program per se for executing the transferred program can be described not relying of the architecture.

In such construction, for efficient execution, the program executing the transferred program and the transferred program per se are frequently executed as the same program on a memory space. The reason is that execution speed of the transferred program can be maximized in this method.

However, in loading the normal interpreter system which is not thought of execution of a plurality of programs in single memory space, a problem is encountered in that Kernel executed on the physically same memory space cannot appropriately perform protection of resource or fair assignment of the resource between logically plurality of programs to be executed on the physically same memory space. Robert Wahbe et al. “Efficient Software-Based Fault Isolation” (Proceeding of 14th ACM Symposium on Operating Systems Principles, pp 203 to 216, December 1993) discloses a method to perform program execution safely in the same memory space. However, in this method, only protection for illegal access of the memory is realized and no means is provided for fair distribution of the memory and calculation resource.

In the conventional system set forth above, the system is not constructed for providing specialized service requested by each user of the service. Particularly, the conventional system has no realizing means by which, when the user desires execution of certain process, the desired process is freely expressed as program or request definition, the program or request definition is transferred to the server of the service provider through a general purpose interface, such as browser or the like for executing the process safely and at high speed on the server.

Since the program uploading technology does not thought of common use of server by a plurality of users, there is no guarantee for security in execution. The mobile agent technology has no function for uploading the program to the server from the remote place or for managing execution. When the mobile agent function is used in place, since dedicated execution environment is required in the user terminal and the server, the service cannot be used unless preliminary preparation of the terminal. On the other hand, another problem is encountered in that the communication amount between the client and server is large and security cannot be ensured.

On the other hand, in the conventional system, when the request of the user is continuous process requiring external communication and storing of the executing condition of the process, there is no means to realize such request. Also, since the automatic monitoring system is not thought of application other than monitoring, it is not possible to store the executing condition which is not required for monitoring. In the system for storing own executing condition by each individual processing program, and the process includes interaction of the executing conditions of outside of the server and other process, it is not possible to certainly store the conditions without discrepancy.

Furthermore, when the program execution function is constructed on the interpreter for solving the foregoing problem, it is difficult to fair distribution of the resource or protection thereof between a plurality of programs to be executed and Kernel controlling their execution.

### SUMMARY OF THE INVENTION

The present invention has been worked out in view of the problems set forth above. It is therefore an object of the present invention to provide a program execution service providing system, a server, a method thereof and a storage medium storing the program, which can realize a system receiving specialized service adapted for request of each of users of services.

Another object of the present invention is to provide a program execution service providing system, a server, a method thereof and a storage medium storing the program, which can certainly store the executing condition without discrepancy even when the process is continuous process requiring storing of the executing condition and includes interaction of outside of the system and other process.

A further object of the present invention is to provide a program execution service providing system, a server, a method thereof and a storage medium storing the program, which can realize the system with fair distribution and protection of the resource on the existing interpreter system.

A program execution service providing system, according to the present invention, comprises:

a client connecting mechanism permitting a client to connect to a server via a network;

a program management mechanism individually reading any one of a program uploaded by the client and a program preliminarily prepared in the server vis the client connectiong mechanism;

a program verification and conversion mechanism verifying that the program read by the program management mechanism satisfies a nature of security not affecting for the server or other program and converting into a format adapted for execution by the server as required;

a program execution control mechanism controlling at least executing a program converted by the program verification and conversion mechanism and managing the calculation resource to be used fairly among actuated programs;

inter-program communication mechanism for mutual communication of a plurality of programs read by the program management mechanism; and

external device communication mechanism cooperating the program read by the program management mechanism and an external system of the server.

Another program execution service providing system according to the present invention, realizes the program and the server at least on a byte code interpreter as a single address space and the same program.

A further program execution service providing system according to the present invention, further comprises program executing condition storage mechanism for storing executing condition of the actuated program in storage means at an appropriate timing during execution of the program.

A server according to the present invention, comprises:

a client connecting mechanism to be connected to a client via a network;

a program management mechanism individually reading any one of a program uploaded by the client and a program preliminarily prepared in the own system;

a program verification and conversion mechanism verifying that the program read by the program management mechanism satisfies a nature of security not affecting for own system or other program and converting into a format adapted for execution by the own system as required;

a program execution control mechanism controlling at least executing a program converted by the program verification and conversion mechanism and managing the calculation resourde to be used fairly among actuated programs;

inter-program communication mechanism for mutual communication of a plurality of programs read by the program management mechanism; and

external device communication mechanism cooperating the program read by the program management mechanism and an external system of the own system.

Another server, according to the present invention, realizes the program and the server at least on a byte code interpreter as a single address space and the same program.

A further server according to the present invention, further comprises program executing condition storage mechanism for storing executing condition of the actuated program in storage means at an appropriate timing during execution of the program.

A program execution service providing method, according to the present invention, comprises:

first step of permitting a client to connect to a server via a network;

second step of individually reading any one of a program uploaded by the client and a program preliminarily prepared in the server;

third step of verifying that the read program satisfies a nature of security not affecting for the server or other program and converting into a format adapted for execution by the server as required;

fourth step of controlling at least executing the read program and managing the calculation resaurce to be used fairly among actuated programs;

fifth step of establishing mutual communication of a plurality of read programs; and

sixth step of cooperating the read program and an external system connected to the server.

Another program execution service providing method according to the present invention, realizes the program and the server at least on a byte code interpreter as a single address space and the same program.

A further program execution service providing method according to the present invention, further comprises seventh step of storing executing condition of the actuated program in storage means at an appropriate timing during execution of the program.

A storage medium storing a program of a program execution service providing method, according to the present invention, comprises:

first process of permitting a client to connect to a server via a network;

second process of individually reading any one of a program uploaded by the client and a program preliminarily prepared in the server;

third process of verifying that the read program satisfies a nature of security not affecting for the server or other program and converting into a format adapted for execution by the server as required;

fourth process of controlling at least executing the read program and managing the calculation resource to be used fairly among actuated programs;

fifth process of establishing mutual communication of a plurality of read programs; and

sixth process of cooperating the read program and an external system connected to the server.

Another storage medium storing the program of the program execution service providing method, according to the present invention, realizes the program and the server at least on a byte code interpreter as a single address space and the same program.

A further storage medium storing the program of the program execution service providing method, according to the present invention, further comprises the seventh process for storing executing condition of the actuated program in storage means at an appropriate timing during execution of the program.

Namely, in the program execution service providing system according to the present invention, the agent server has the verification and conversion mechanism of the program which is uploaded to guarantee protection from the uploaded program, protection from the executing condition of other programs and from other executing conditions of the same program and proper distribution of the computer resource, such as CPU, memory and so forth.

On the other hand, in the program execution service providing system according to the present invention, the executing condition of the program is managed by the server and the system has executing condition storage mechanism cooperated with the communication mechanism to store the executing condition in the external storage or the like at an appropriate timing for certainly enabling execution of the process requiring to store the executing condition.

Furthermore, in the program execution service providing system, not only by actuating the program through the communication mechanism, by the user, but also by obtaining the result of execution of the past actuated program and the executing condition of the program on execution, arbitrary process desired by the user can be executed by the server and the user can operate the server.

More particularly, the program execution service providing system according to the present invention has the agent server unit including the client communication mechanism, the user management mechanism, the program management mechanism, the program verification and conversion mechanism, the program execution control mechanism, the inter-program communication mechanism, the external device communication mechanism and the program executing condition storage mechanism.

The user establishes connection with the server through the client communication mechanism and receives authentication of the user management mechanism. Then, the user can use other mechanism in the server via the client communication mechanism. When other mechanism is used, the connected user information is transferred to the mechanism to be used as user information.

At first, the user uploads the program describing the desired process to the server via the client communication mechanism using the program management mechanism. The program management mechanism verifies the received program whether it contains secure code or not using the program verification and conversion mechanism, and in conjunction therewith, converts the received program into a format adapted for operation on the server. The program thus converted is stored in the external storage device.

Subsequently, the user designates initiation of execution of the program to the program execution control mechanism through the client communication mechanism. The program execution control mechanism is responsive to designation to take out the designated program in converted form from the program management mechanism to actuate as a part of the function of the server and manages execution until the end of the program irrespective whether the user is connected through the client communication mechanism. On the other hand, the executing condition is stored in the memory or the external storage device at a proper timing by the program executing condition storage mechanism.

The programs on execution communicate with executing condition of other program or outside of the server via the inter-program communication mechanism. When communication is caused, the executing condition storage mechanism stores the executing condition of the process together with communication content.

The user also communicates with the program on execution through the client communication mechanism and the inter-program communication mechanism to obtain halfway condition of the execution and provide instruction for varying operation. On the other hand, the user establishes connection with the program executing condition control mechanism via the client communication mechanism to obtain a list of programs on execution and to stop program on execution.

In the program execution service providing system, both of the server computer and the client computer are connected to the network to communication over the network. The agent server unit is operated on the server computer.

With the construction set forth above, the program execution service providing system according to the present invention enables the user to upload the requesting process in a form of program (user program) to the server to control execution. Also, in the environment where the server of the shown system and the user program are operate as the same program, it becomes possible to execute the programs without mutually and adversely affecting with each other. Also, upon occurrence of failure during server operation and stoppage of the server, it becomes possible to continue execution of the user program without causing discrepancy after rebooting.

When the user desires execution of certain single turn or continuous process, and respective desired process are freely expressed as program or request definition. Then, the program or request definition thus generated is transferred to the server of the service provider to make it possible to safely process on the server. Therefore, the system, on which the user of the service may receive the service, specialized for own request, can be realized.

On the other hand, when the process is the continous process requiring storage of the executing condition and includes interaction with the outside of the system or other process, the executing condition can be certainly stored without discrepancy to realize the system with fair distribution and protection of the resource on the existing interpreter system.

### BRIEF DESCRIPTION OF THE DRAWINGS

The present invention will be understood more fully from the detailed description given hereinafter and from the accompanying drawings of the preferred embodiment of the present invention, which, however, should not be taken to be limitative to the invention, but are for explanation and understanding only.

In the drawings:

FIG. 1 is a block diagram showing a construction of an embodiment of an agent server system according to the present invention;

FIG. 2 is a block diagram showing use mode of the embodiment of the agent server system according to the present invention;

FIG. 3 is a block diagram showing a construction of the first embodiment of a program execution service providing system according to the present invention;

FIG. 4 is an illustration showing an example of description of a program which can be uploaded by a user in one embodiment of the present invention;

FIG. 5 is a flowchart showing operation of a client communication mechanism of FIG. 3;

FIG. 6 is a flowchart showing operation of a client communication mechanism of FIG. 3;

FIG. 7 is an illustration showing a construction of a user information table having a user management mechanism of FIG. 3;

FIG. 8 is a flowchart showing operation of a program management mechanism of FIG. 3;

FIG. 9 is an illustration showing a construction of a program table of FIG. 3;

FIG. 10 is a flowchart showing operation of a program execution control mechanism of FIG. 3;

FIG. 11 is an illustration showing a construction of a management table of a program on execution to be stored in the program execution control mechanism of FIG. 3;

FIG. 12 is a block diagram showing a construction of a program executing condition of FIG. 3;

FIG. 13 is an illustration showing a data structure of a program executing condition database managed by a program executing condition storing mechanism of FIG. 3;

FIG. 14 is a flowchart showing operation of the program executing condition storing mechanism of FIG. 3;

FIG. 15 is a block diagram showing a construction of an inter-program communication mechanism of FIG. 3;

FIG. 16 is a flowchart showing operation of the inter-program communication mechanism of FIG. 3;

FIG. 17 is a flowchart showing operation of a scheduler of FIG. 3;

FIG. 18 is a flowchart showing operation upon actuation of the agent server system of FIG. 3;

FIG. 19 is a flowchart showing operation of a program verification and conversion mechanism of FIG. 3;

FIG. 20 is a flowchart showing operation of a program verification and conversion mechanism of FIG. 3;

FIG. 21 is a flowchart showing operation of the second embodiment of a program management mechanism according to the present invention;

FIG. 22 is a block diagram showing a construction of the fourth embodiment of the program execution service providing system according to the present invention;

FIG. 23 is a block diagram showing a construction of the fifth embodiment of the program execution service providing system according to the present invention;

FIG. 24 is an illustration of a data structure of an accounting database of FIG. 23;

FIG. 25 is a flowchart showing operation of the program management mechanism of FIG. 23;

FIG. 26 is a flowchart showing operation of a program execution control mechanism of FIG. 23;

FIG. 27 is a flowchart showing operation of the scheduler of FIG. 23;

FIG. 28 is a flowchart showing operation of the eighth embodiment of the scheduler according to the present invention;

FIG. 29 is a flowchart showing operation of the eighth embodiment of the inter-program communication mechanism according to the present invention; and

FIG. 30 is a block diagram of a use mode of the ninth embodiment of the agent server system according to the present invention.

### DESCRIPTION OF THE PREFERRED EMBODIMENT

The present invention will be discussed hereinafter in detail in terms of the preferred embodiments of the present invention with reference to the accompanying drawings. In the following description, numerous specific details are set forth in order to provide a thorough understanding of the present invention. It will be obvious, however, to those skilled in the art that the present invention may be practiced without these specific details. In other instance, well-known structure is not shown in detail in order to avoid unnecessary obscurity of the present invention.

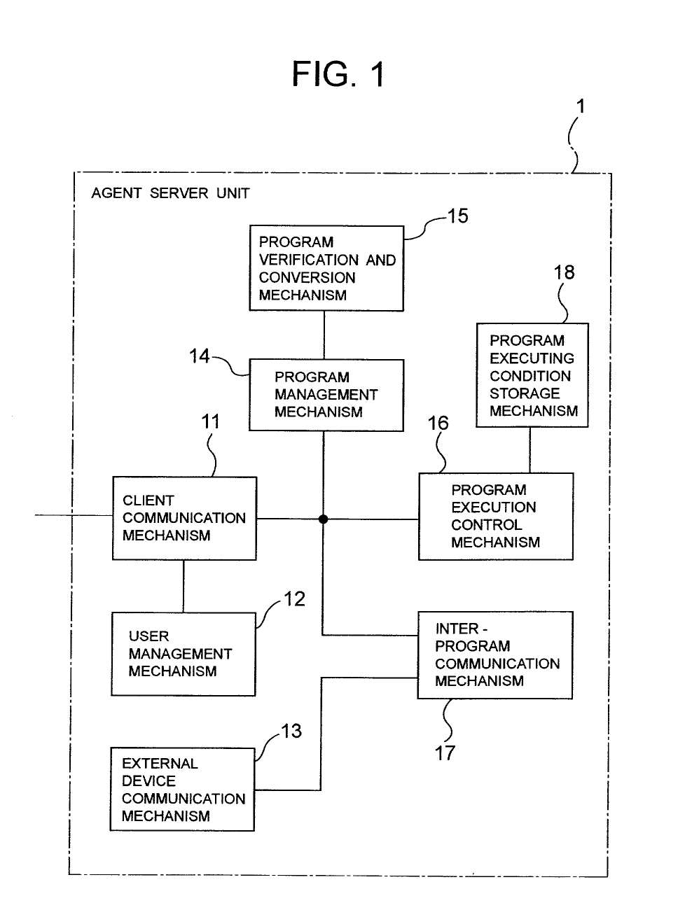

FIG. 1 is a block diagram showing a construction of an embodiment of an agent server system according to the present invention. In FIG. 1, the agent server system 1 includes a client communication mechanism 11, a user management mechanism 12, an external equipment communication mechanism 13, a program management mechanism 14, a program verification and conversion mechanism 15, a program execution control mechanism 16, an inter-program communication mechanism 17 and a program executing condition storage mechanism 18.

A user establishes connection with a server (not shown) through the client communication mechanism 11. Upon authentication of the user management mechanism 12, the user may use other mechanism in the server. When other mechanism is used, the connected user information is transferred to the mechanism to be used as user information.

At first, the user uploads a program describing a desired process via the client communication mechanism 11 using the program management mechanism 14, to the server. The program management mechanism 14 verifies the received program whether it contains safe code or not by the program verification and conversion mechanism 15, and in conjunction therewith, converts the received program into a format appropriate for operation on the server to store in an external storage device (not shown).

Subsequently, the user commands initiation of execution of the program to the program execution control mechanism 16 through the client communication mechanism 11. The program execution control mechanism 16 is responsive to the command from the user to take out the converted program as designated from the program management mechanism 14 to actuate as a part of the function of the server and manages execution of the program to end irrespective whether the user is connected to the client communication mechanism 11 or not. On the other hand, the executing condition is stored in a memory (not shown) or the external storage device at an appropriate timing by the program executing condition storing mechanism 18.

The program on execution communicates with other program on execution or outside of server via the inter-program communication mechanism 17. Upon occurrence of communication, the program executing condition storing mechanism 18 stores the executing condition of the process together with the communication content.

The user also communicates with the program on execution via the client communication mechanism 11 and the inter-program communication mechanism 17 to obtain a condition in process of execution or to command for changing operation. On the other hand, the user establishes connection with the program execution control mechanism 16 via the client communication mechanism 11 to obtain a list of programs on execution and stop execution of the program.

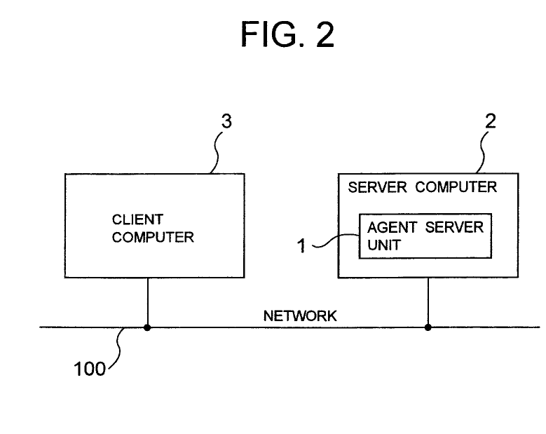

FIG. 2 is a block diagram showing use mode of the embodiment of agent server system 1 according to the present invention. In FIG. 2, a server computer 2 and a client computer 3 are both connected to a network 100 to communicate through the network 100. The agent server system 1 operates on the server computer 2.

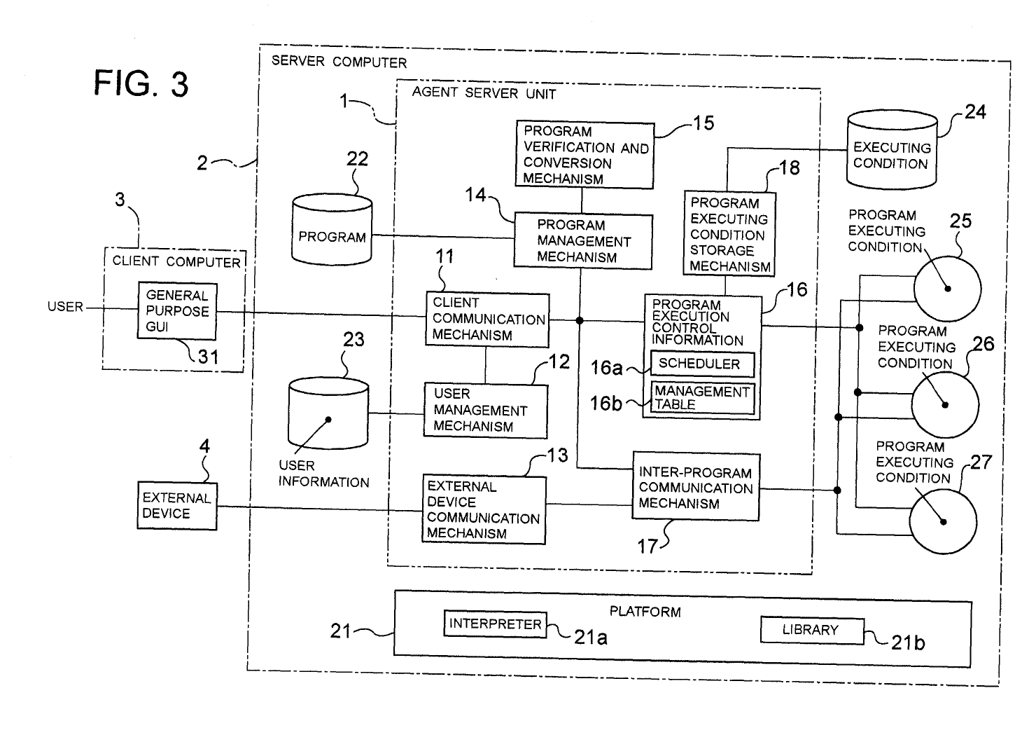

FIG. 3 is a block diagram showing a construction of the first embodiment of a program execution service providing system according to the present invention. In FIG. 3, the first embodiment of the program execution service providing system is constructed with the server computer 2 loaded the agent server system 1, the client computer 3 loaded a general purpose Graphic User Interface (GUI) and an external equipment 4.

The agent server system 1 and an environment using the same is consisted of the server computer 2 connected to the network, the client computer 3 as terminal connected to the server computer 2 on the network to be used by the user, a general program execution platform (hereinafter referred as platform) 21 having an interpreter 21a and a library 21b executed on the server computer 2, and a general purpose GUI 31 operated on the client computer 3.

Here, the preferred embodiment of the platform 21 is an execution environment of Java language as a language of interpreter system. The preferred embodiment of the general purpose GUI 31 is WWW (WorldWide Web) browser. In the following discussion, the execution environment of Java language is used.

The agent server system 1 operates on the platform 21 on the server computer 2. The agent server system 1 is constructed with the client communication mechanism 11, the user management mechanism 12 including a user information table 23, an external equipment communication mechanism 13, the program management mechanism 14 including a program table 22, the program verification and conversion mechanism 15, the program execution control mechanism 16 having the scheduler 16a and a management table 16b, an inter-program communication mechanism 17 and the program executing condition storage mechanism 18 connected to the program executing condition database 24 stored serialized program executing condition.

In the shown embodiment, the program which can be uploaded by the user is not normal program but is described as group of execution units explicitly managed the executing condition by the program per se. The user program is called at an appropriate timing and in a given format by the server computer 2. Each program performs fraction of process whenever it is called by the server computer 2.

Each of the actuated programs has own and distinct data region to progress execution of the program with appropriately making reference to data stored in each own data region. This data region becomes the program executing condition. The program to be executed is responsive to call from the server computer 2 to be required to complete own process within a relatively short period and to return the control to the server computer 2.

As set forth above, by restricting describing method of the program to be executed, it is advantageous to realize multi-process relatively easily. On the other hand, in this method, since it is not required to perform low level process, such as interrupt or complicate stacking process, it is suitable for mounting in Java language as the preferred embodiment of the present invention.

On the other hand, the program which can be uploaded by the user, can call several instruction according to a format determined by the agent server system 1 when the program uses the function of agent server system 1. Kinds of instructions are message sending, message reception, temporary interrupt of program execution and so forth.

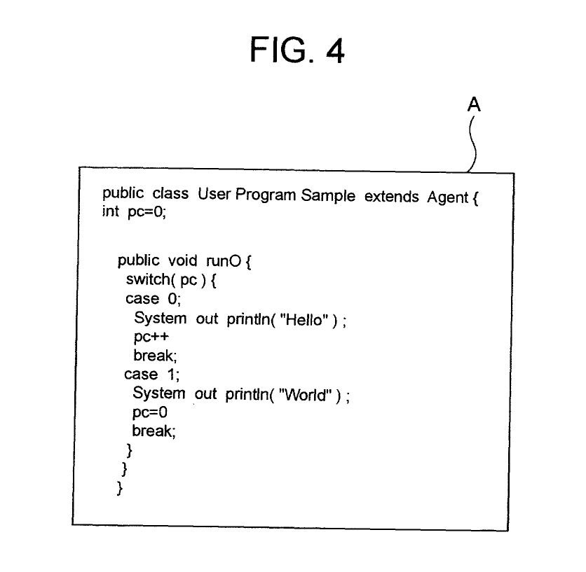

FIG. 4 is an illustration showing an example of description of the program which can be uploaded by the user in one embodiment of the present invention. FIG. 4 shows an example of description of the program by Java language as preferred embodiment of the present invention.

A program A mounts a method run as common interface for programs which can be uploaded, to be called by the agent server system 1 and an instant parameter pc which is data to be managed by the program. One execution unit by the agent server system 1 corresponds to one call of run method.

The agent server system 1 repeatedly calls the run method. The program varies operation from time to time depending upon the value of the parameter pc as called. An instance of User Program Sample class having the instant parameter pc becomes program executing condition.

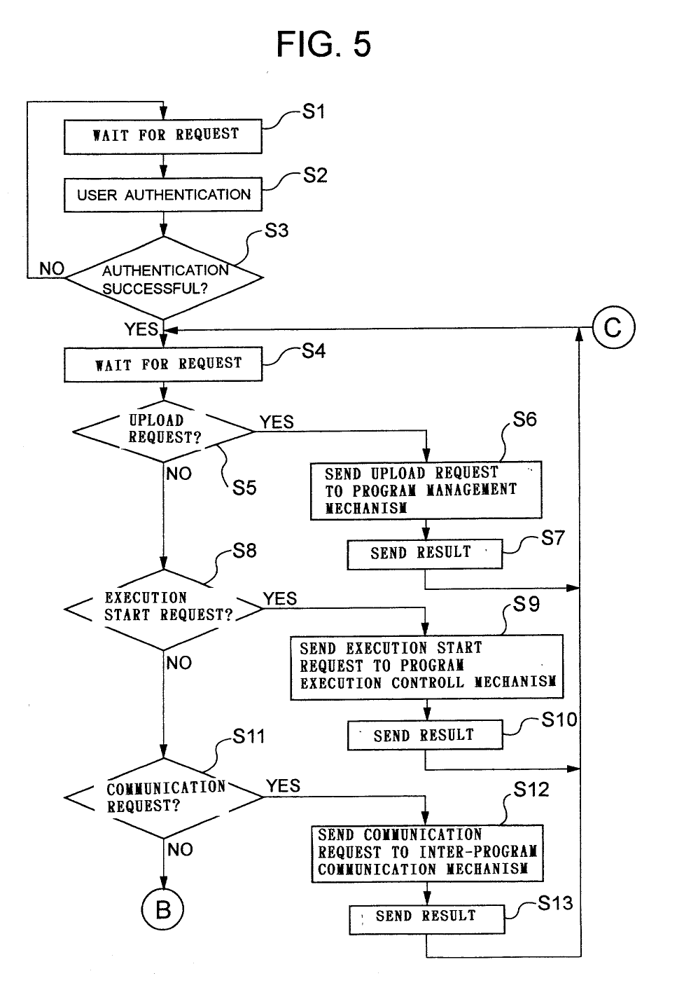

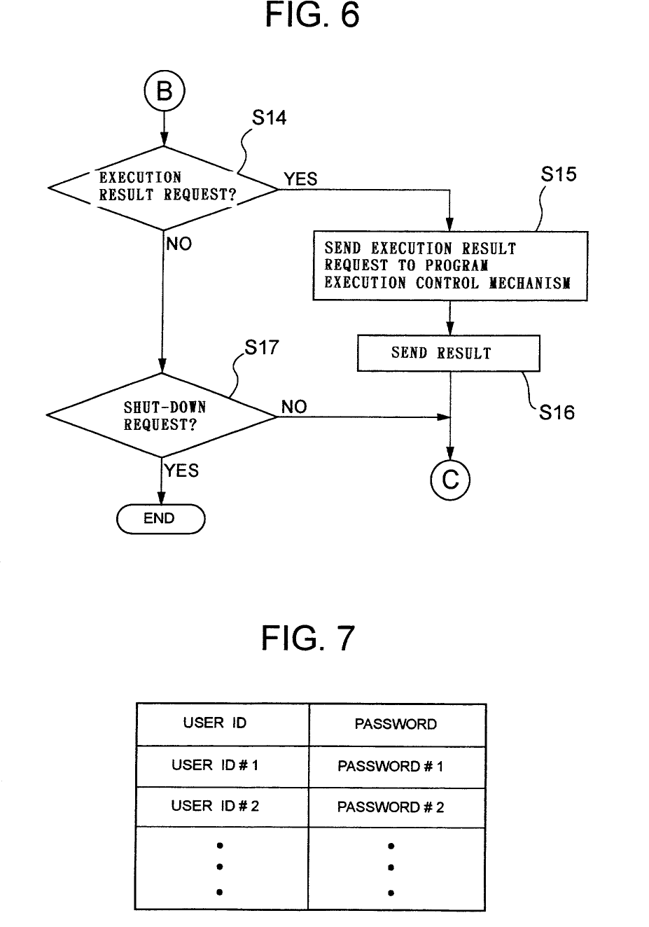

FIGS. 5 and 6 are flowcharts showing operation of the client communication mechanism 11 of FIG. 3. Operation of the client communication mechanism 11 will be discussed with reference to FIGS. 3, 5 and 6.

The client communication mechanism 11 waits for connection from the client computer 3 (step S1 of FIG. 5). When connection with the client computer 3 is established, user authentication is performed (step S2 of FIG. 5). When the user authentication is successful (step S3 of FIG. 5), the client communication mechanism 11 is situated into a state of waiting for other request.

In request waiting state, the client communication mechanism 11 receives communication request of program uploading, program execution start, communication with program executing state, obtaining of program execution result and so forth. In case of uploading request (step S5 of FIG. 5), uploading request is sended to the program management mechanism 14 (step S6 of FIG. 5) and returns the result (step S7 of FIG. 5).

In case of the execution start request (step S8 of FIG. 5), the client communication mechanism 11 sends execution start request to the program execution control mechanism 16 (step S9 of FIG. 5) to return the result (step S10 of FIG. 5). In case of the communication request (step S11 of FIG. 5), the client communication mechanism 11 sends the communication request to the inter-program communication mechanism 17 (step S12 of FIG. 5) to return the result (step S13 of FIG. 5).

In case of execution result request (step S14 of FIG. 6), the client communication mechanism 11 sends the execution result request to the program execution control mechanism 16 (step S15 of FIG. 6) to return the result (step 16 of FIG. 6) On the other hand, in case of shut down request (step S17 of FIG. 6), the client communication mechanism 11 returns to step S4 to be situated in request waiting state.

Here, the client communication mechanism 11 is built in a Hypertext Transfer Protocol (HTTP) server function, and communicates, with the WWW browser using the HTTP protocol.

When the user management mechanism 12 receives an authentication request from the client communication mechanism 11, an authentication information provided by the user is compared with the user information managed by itself. If the authentication information matches with the user information, the user management mechanism 12 issues permission for establishing connection. On the other hand, if the authentication information matches with the user information, the user management mechanism 12 issues rejection for connection. The authentication information and the user information are respectively consisted of user ID and password.

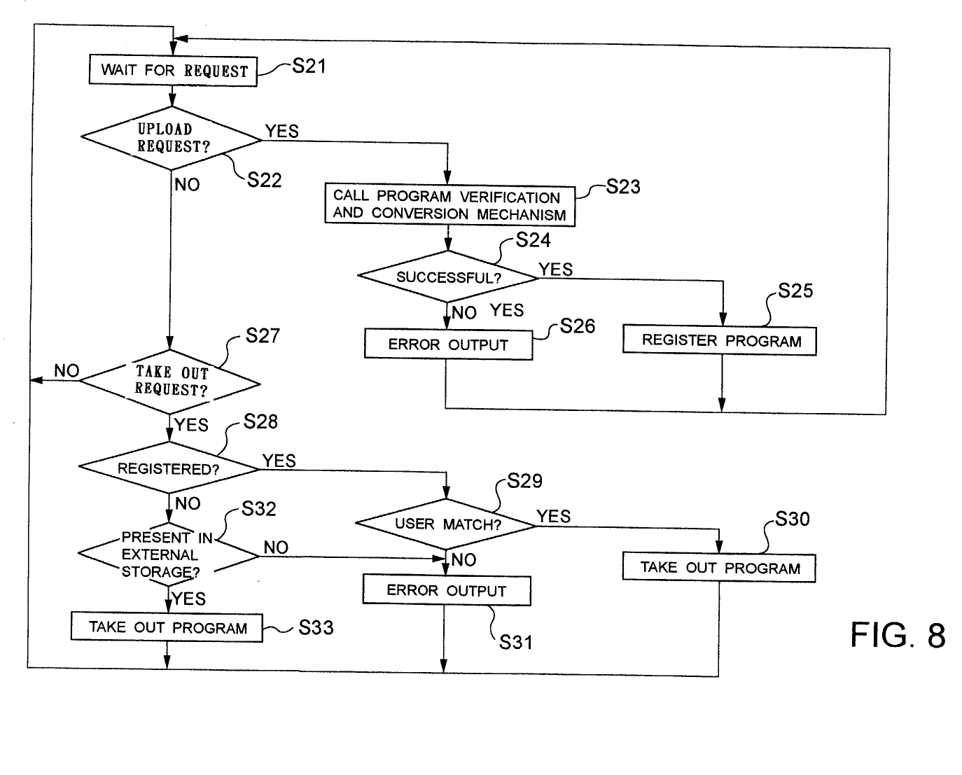

FIG. 7 shows a structure of the user information table 23 which the user management mechanism 12 of FIG. 3 has. In FIG. 7, the user information table 23 is consisted of user ID, “user ID #1”, “user ID #2” and passwords “password #1”, “password #2”.

FIG. 8 is a flowchart showing operation of the program management mechanism 14 of FIG. 3. Discussion will be given for operation of the program management mechanism 14 with reference to FIGS. 3 and 8.

The program management mechanism 14 waits for request from both of the client communication mechanism 11 and the program execution control mechanism 16 (step S21 of FIG. 8). The program management mechanism 14 is responsive to the program upload request from the client communication mechanism 11 (step 22 of FIG. 8) and calls the program verification and conversion mechanism 15 (step S23 of FIG. 8) to verify security of the program and in conjunction therewith to convert the program into a format adapted to execution on the server computer 2.

When verification and conversion by the program verification and conversion mechanism 15 is successful (step S24 of FIG. 8), the program management mechanism 14 registers the program in the program table 22 together with the user ID of the user who issued the uploading request, and program names before and after conversion (step S25 of FIG. 8). In this case, if verification and conversion by the program verification and conversion mechanism 15 is not successful, the program management mechanism 14 issues error output (step S26 of FIG. 8).

On the other hand, the program management mechanism 14 is responsive to a program take out request designating the program name fed from other mechanism (S27 of FIG. 8) to check whether the program having the designated program name as the program name before conversion is registered or not (step S28 of FIG. 8). If the program having the designated program name as the program name is present in the registered program names, check is performed whether the stored user and the requested user are the same or not (step S29 of FIG. 8). If the user name and the requested name are the same, the program is taken out (step S30 of FIG. 8). If the user is not the same as the requested user, the program management mechanism 14 issues error output (step S31 of FIG. 8).

Also, when the requested program is not present in the program table 22 (not registered), the program management mechanism 14 further checks the external storage device whether the requested program name as the program name before conversion is present or not (step S32 of FIG. 8). If the program name is present in the external storage device, the corresponding program is readout (stepS33 of FIG. 8). If the requested program name is not found even in the external storage device, the program management mechanism 14 issues the error output (step S31 of FIG. 8).

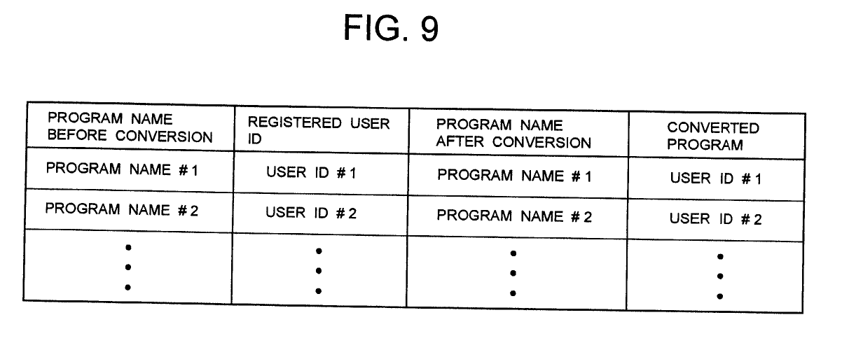

FIG. 9 is an illustration showing a structure of the program table 22 of FIG. 3. In FIG. 9, the program table 22 is consisted of the program name before conversion, “program name #1”, “program name #2”, the registered user ID, “user ID #1”, “user ID #2”, the program name after conversion, “program name #1”, “program name #2”, and the program after conversion, “program #1”, “program #2”.

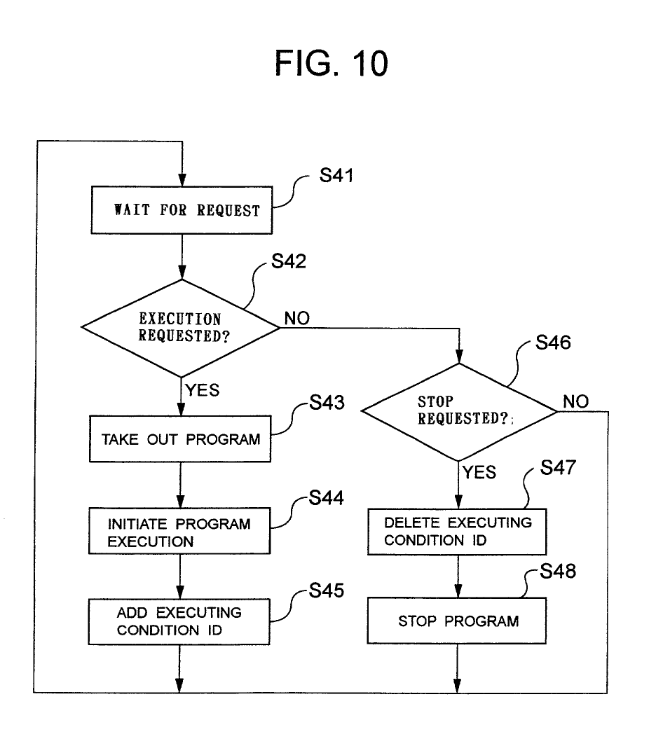

FIG. 10 is a flowchart showing operation of the program execution control mechanism 16 of FIG. 3. Operation of the program execution control mechanism 16 will be discussed with reference to FIGS. 3 and 10.

The program execution control mechanism 16 waits for the request (step S41 of FIG. 10). When the program execution request is received from the client communication mechanism 11 (step S42 of FIG. 10), the designated program is read out from the program management mechanism 14 (step S43 of FIG. 10) to start execution thereof (step S44 of FIG. 10). Then, the ID in executing condition is added to the management table 16b together with the ID of the user who actuated the program (step S45 of FIG. 10).

On the other hand, the program execution control mechanism 16 makes reference to the executing condition and is responsive to a program stop request (step S46 of FIG. 10) to delete information of the corresponding program ID from the management table 16b (step S47 of FIG. 10) and to stop executing condition of the designated program (step S48 of FIG. 10). The designated program is deleted from the memory and the program executing condition storage mechanism 18.

The program execution control mechanism 16 deletes the program executing condition only when the program stop request is explicitly received. When execution is completed by the program per se, the program is simply interrupted temporarily and is not deleted to wait for explicit request for deletion after making reference to the result of execution by the user.

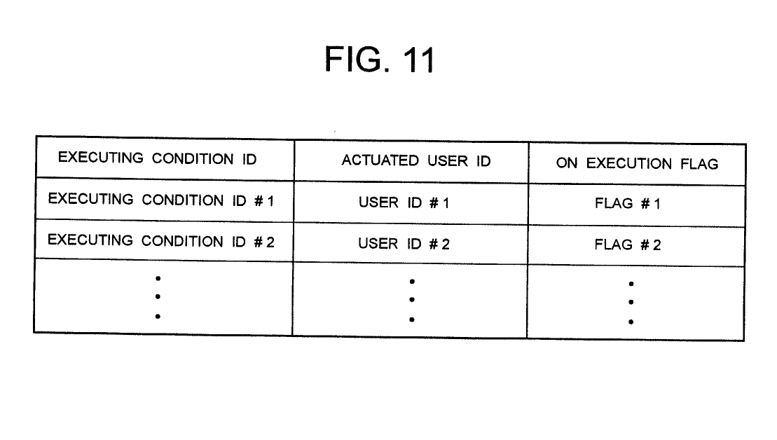

FIG. 11 is an illustration showing a structure of the management able 16b of the program in execution stored in the program execution control mechanism 16 of FIG. 3. In FIG. 11, the management table 16b is consisted of the executing condition ID, “executing condition ID #1”, “executing condition ID #2”, the actuated user ID “user ID #1”, “user ID #2”, and on-execution flag, “flag #1”, “flag #2”.

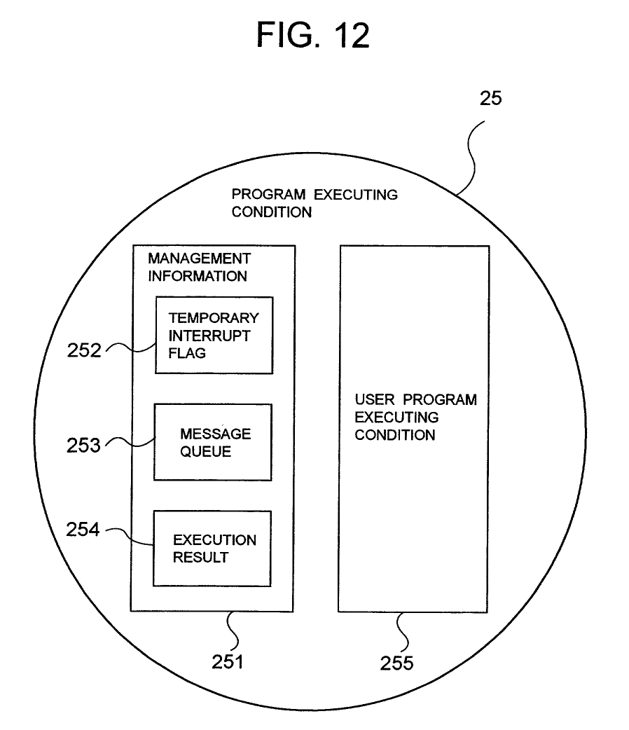

FIG. 12 is a block diagram showing a construction of a program executing condition 25 of FIG. 3. In FIG. 12, the program executing condition 25 is consisted of an executing condition 255 of the user program and a management information 251 of the program executing condition. The management information 251 is consisted of a temporary interrupt flag 252 indicating whether the program is temporarily interrupted or not, a message queue 253 to be used by the inter-program communication mechanism 17 and an execution result 254 upon completion of program execution.

The program described by the user temporarily interrupts continuation of execution of the program by turning on the temporary interrupt flag 252 of own program executing condition. Simultaneously, the temporary interrupt instruction may designate a temporarily interrupting period. When the temporarily interrupting period is designated, after expiration of the designated period from calling of the instruction, the temporary interrupt flag is turned off by the agent server system 1 for resuming execution of the program.

On the other hand, when the program executing condition as temporarily interrupted receives the message via the inter-program communication mechanism 17, temporary interrupt is released automatically to continue execution. The program executing condition storage mechanism 18 stores the executing condition of the designated program in the external storage device.

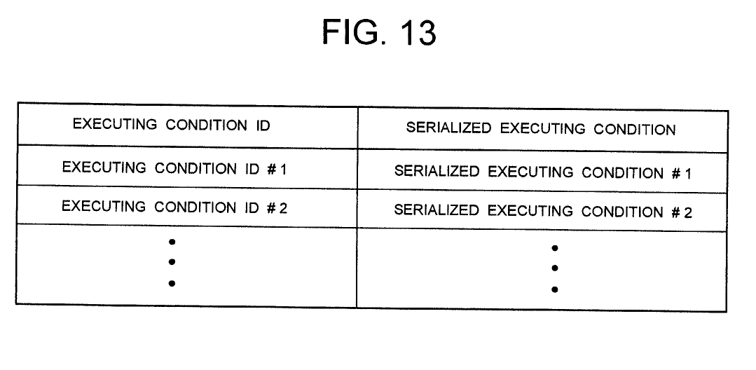

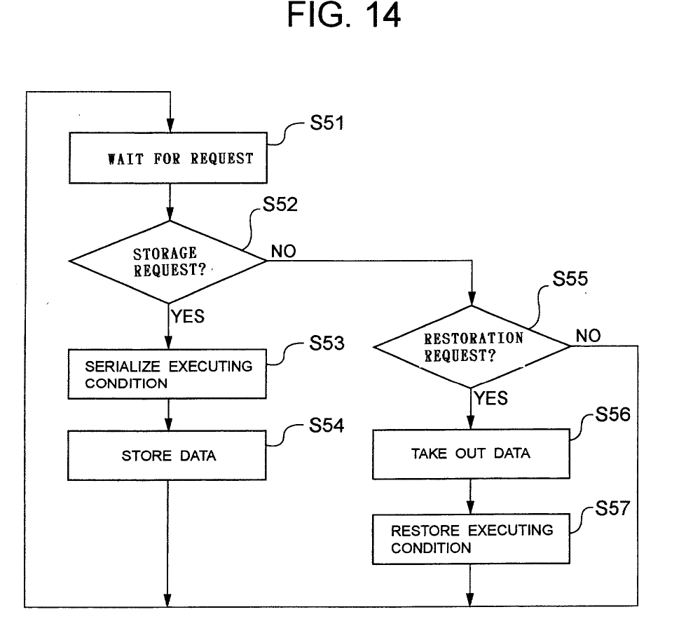

FIG. 13 is an illustration showing a data structure of the program executing condition database 24 managing the program executing condition storage mechanism 18 of FIG. 3. In FIG. 13, the program executing condition database 24 is consisted of the executing condition ID, “executing condition ID #1”, “executing condition ID #2” and a serialized executing condition, “serialized executing condition #1”, “serialized executing condition #2”.

FIG. 14 is a flowchart showing operation of the program executing condition storage mechanism 18 of FIG. 3. Operation of the program executing condition storage mechanism 18 will be discussed with reference to FIGS. 3 and 14.

The program executing condition storage mechanism 18 waits for the request (step S51 of FIG. 14). When the program executing condition (storage request) is transferred from the scheduler 16a (step S52 of FIG. 14), the program executing condition is serialized (step S53 of FIG. 14) to store together with the executing condition ID (step S54 of FIG. 14).

On the other hand, when restoration of the executing condition is requested designating reference information (step S55 of FIG. 14), the program executing condition storage mechanism 18 takes out the serialized executing condition from the program executing condition database 24 (step S56 of FIG. 14) for restoring the serialized executing condition to the original executing condition (step S57 of FIG. 14).

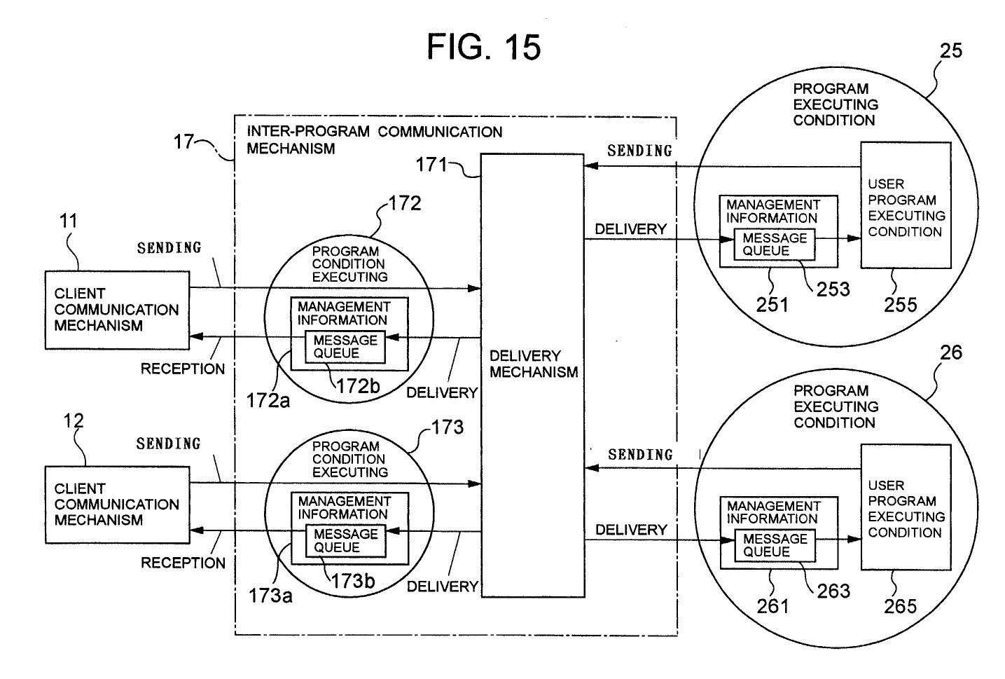

FIG. 15 is a block diagram showing a construction of the inter-program communication mechanism 17 of FIG. 3. In FIG. 15, the inter-program communication mechanism 17 provides an asynchronous message delivery function. The inter-program communication mechanism 17 includes a message delivery mechanism 171 performing delivery to the message queue 253 and 263 in the program executing conditions 25 and 26, a special program executing condition 172 for the client communication mechanism 11, and a special program executing condition 173 for the external device communication mechanism 12. The program may perform communication by explicitly requesting sending and reception of the message to the inter-program communication mechanism 17.

The program executing conditions 172 and 173 include management information 172a and 173a mounting message queue 172b and 173b therein. The program executing conditions 25 and 26 includes management information 251 and 261 mounting message queues 253 and 263, and user program executing conditions 255 and 265.

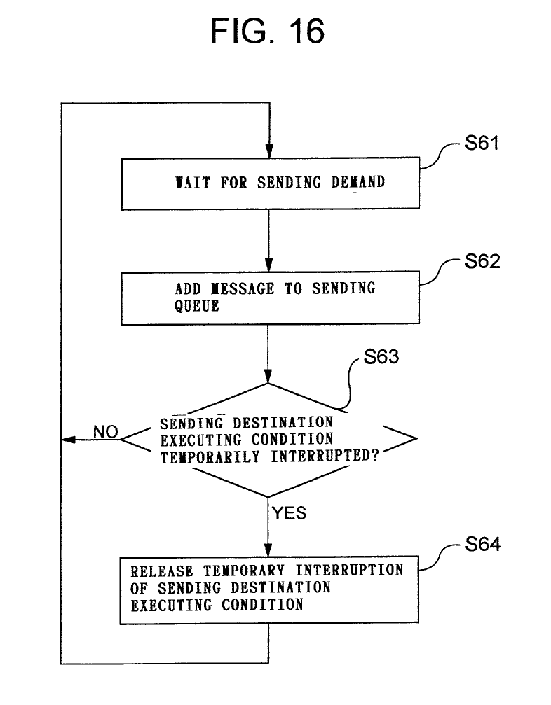

FIG. 16 is a flowchart showing operation of the inter-program communication mechanism 17 of FIG. 3. Operation of the inter-program communication mechanism 17 will be discussed with reference to FIGS. 3, 15 and 16.

When the program executing condition requests sending of the message directed to other executing condition (step S61 of FIG. 16), the inter-program communication mechanism 17 receives a message sending request. Then, the inter-program communication mechanism 17 enters the designated message to the message queue of designated other executing condition (step S62 of FIG. 16).

Subsequently, the inter-program communication mechanism 17 checks whether the designated executing condition is in temporarily interrupted state or not (step S63 of FIG. 16). If the designated executing condition is in temporarily interrupted state, temporary interrupted state is released (step S64 of FIG. 16).

On the other hand, when the executing condition which received the message requests the message reception in the program, the message is taken out from the own message queue and is transferred to the program.

The client communication mechanism 11 and the external device communication mechanism 12 also use the inter-program communication mechanism 17 similarly to the program executing condition. So that these may be handled similarly to the normal program executing condition, special program executing conditions 172 and 173 are provided in the inter-program communication mechanism 17. While these special program executing conditions 172 and 173 are not managed by the program execution control mechanism 16, but are stored by the program executing condition storage mechanism 18 in order to store the communicating condition.

The scheduler 16a controls behavior with respect to executing condition of the program registered in the management table 16b and has a function to make the actual program to be executed. The scheduler 16a operates by repeating group of processes called as “turn”.

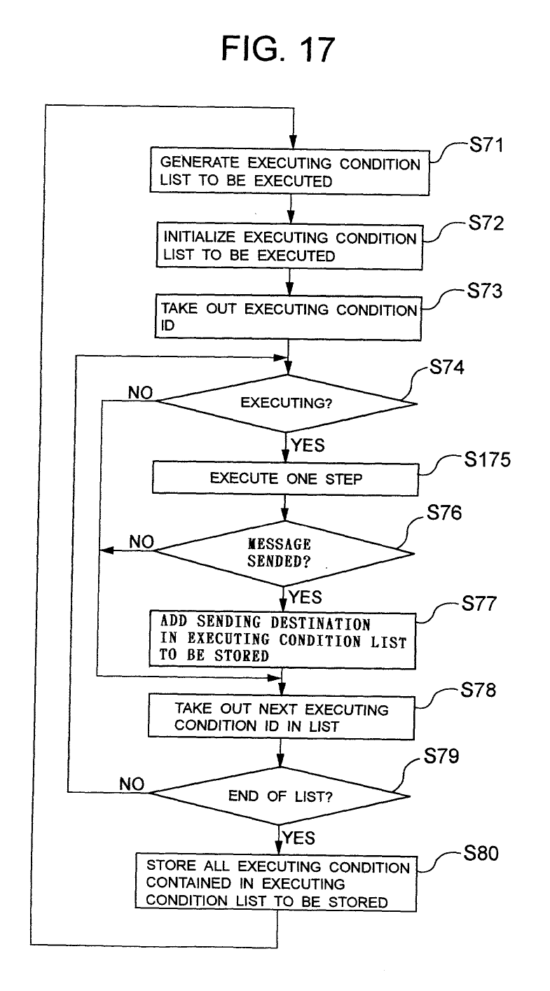

FIG. 17 is a flowchart showing operation of the scheduler 16a of FIG. 3. Operation of the scheduler 16a will be discussed with reference to FIGS. 3 and 14.

At first in the turn, the scheduler 16a selects executing condition of the program to be executed within the turn among the executing condition ID of the programs registered in the management table 16b and lists those (step S71 of FIG. 17).

Next, the scheduler 16a sets a list the same as the list of executing condition to be executed as an initial value of the list of the executing condition to be stored in the final turn (step S72 of FIG. 17).

Subsequently, the scheduler 16a makes judgment whether the program executing condition is on execution or on temporarily interrupted state for all executing conditions contained in the list of the executing conditions to be executed (steps S73 and S74 of FIG. 17). If the executing condition is on execution, only one execution unit of the program may be executed (step S75 of FIG. 17).

When execution of one execution unit is completed, the scheduler 16a checks presence or absence of message sending on execution (step S76 of FIG. 17). When message sending is present, a sending destination executing condition ID is added to the list of the executing condition to be stored (step S77 of FIG. 17). The scheduler 16a repeats the process to the end of the list (steps S74 to S79 of FIG. 17).

Finally, the scheduler 16a transfers all executing conditions contained in the list of the executing conditions to be stored to the program executing condition storage mechanism to store simultaneously (step S80 of FIG. 17). As a result, all of executing conditions which are executed, and all of executing conditions receiving the messages are stored.

When inter-program communication is performed during execution by storing the executing conditions in a lump after execution, the program executing conditions of message sender and sending destination are always stored in either condition that the sender does not yet send the message and the sending destination does not yet receive the message or that the sender sended the message and the sending destination received the message. Even when the agent server unit 1 causes failure to interrupt operation during delivery of the message or storing of the executing condition and resumption of execution thereafter, execution can be continued without causing discrepancy, such as loss or doubling of message delivery or the like.

Furthermore, by simultaneously performing execution and storing of a plurality of program executing conditions in a lump, storing of the executing condition can be performed efficiently when communication is concentrated to particular executing condition, in comparison with the case where only one executing condition is executed and stored at one time.

When ten program executing conditions send messages to one program executing condition, by executing and storing ten executing conditions in a lump to permit storing of the executing condition on the message reception side at one time to require storing of eleven executing conditions in total. In contrast to this, when execution and storing of only one executing condition at one time to require storing of two executing conditions at the message sender and message sending destination to require storing cumulatively twenty executing conditions.

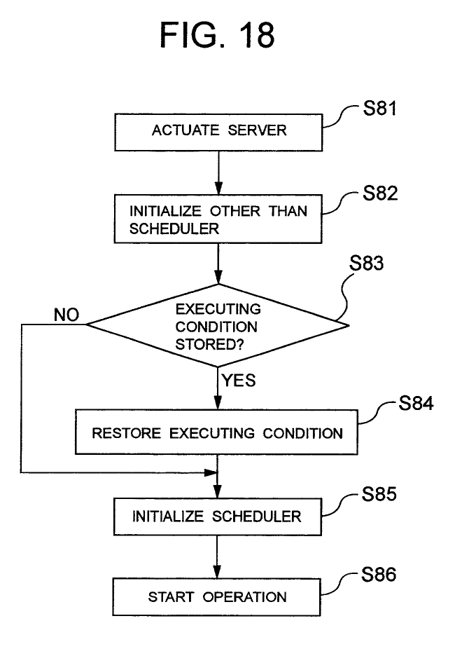

FIG. 18 is a flowchart showing operation of the agent server unit 1 of FIG. 1 upon actuation. Operation of the agent server unit 1 upon actuation will be discussed with reference to FIGS. 3 and 18.

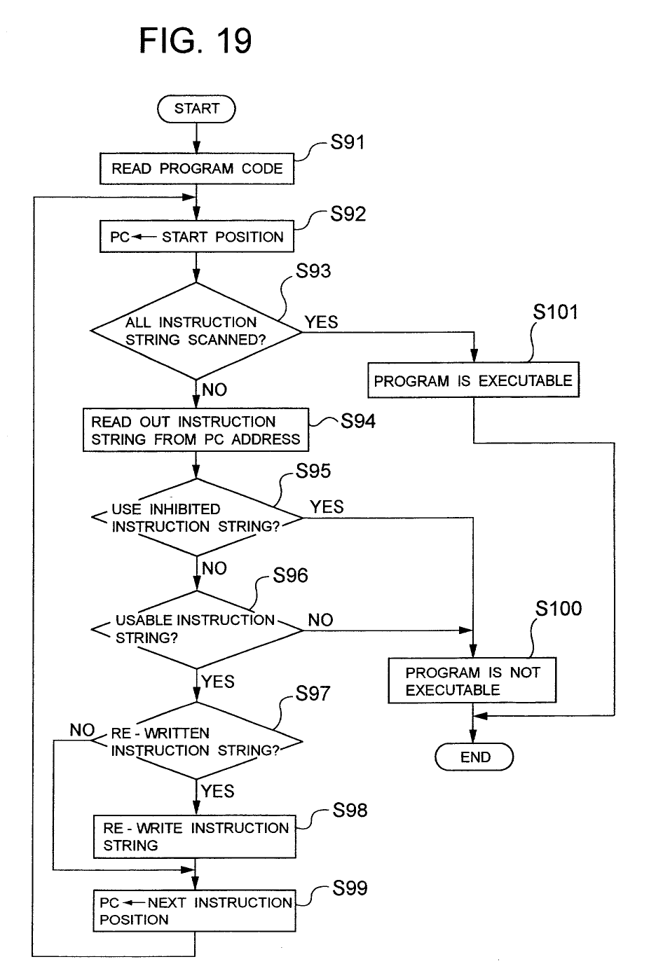

Upon actuation (step S81 of FIG. 19), the agent server unit 1 performs initialization of all mechanism except for the scheduler 16a (step S82 of FIG. 18) for preparation of enabling operation of the agent server unit 1.

Next, the agent server unit 1 checks the program executing condition storage mechanism 18 whether the program executing condition is already stored or not (step S83 of FIG. 18). If already stored, all of stored program executing conditions are restored (step S84 of FIG. 18). Thereafter, the scheduler 16a is initialized to initiate execution of the scheduler 16a (step S85 of FIG. 18). By this, operation of the agent server unit 1 is initiated (step S86 of FIG. 18).

FIG. 19 is a flowchart showing operation of the program verification and conversion mechanism 15 of FIG. 3. Operation of the program verification and conversion mechanism 15 will be discussed with reference to FIGS. 3 and 19.

The program verification and conversion mechanism 15 inhibits execution of instruction which is not desirable to execute by the uploaded program, or performs conversion of the program with maintaining meaning of the program so that excessive amount of calculation resource or memory is not used against intension of the server computer 2.

As an example of instruction sequence inhibited execution, Application Program Interface (API) of the interpreter which stops execution of the server process per se including the uploaded program, may be considered.

When such instruction sequence is executed by the uploaded program, not only the program but also the server process per se stop execution. The present invention ensures security by finding such instruction sequence before execution of the program or re-writing such instruction sequence into secure instruction sequence.

For example, upon mounting using Java language as the preferred embodiment of the present invention, it is possible to find the following instruction sequences.

| | |
|---|---|
| n | iconst_0 |
| n+1 | invokestatic #2 |

The foregoing instruction sequence is a result of translation of “System. exit (0)” in Java language into Java byte code. This expression means stop of execution of Java program executing this expression to stop execution of the server process per se. For preventing this, it is desirable to reject execution of the program including the instruction sequence as set forth above.

On the other hand, for example, upon inspecting a memory amount to be used, in mounting using Java language as the preferred embodiment of the present invention, obtaining of the memory is performed by only following instructions.

new

newarray

anewarray

By re-writing these instructions with adding instruction sequence for discriminating use amount of the memory, use amount of the memory can be restricted.

For example, in case of the instruction sequence of

new class foo,

the instruction sequence is re-written with a following pseudo code:

if (size of class foo+heretofore memory use amount

< memory use amount restriction)

{
Program execution end
}

new class foo.

As set forth above, avoiding of the instruction sequence which is dangerous to execute and restriction of the memory use amount can be easily realized using the program verification and conversion function.

At first, the program verification and conversion mechanism 15 reads the program code (step S91 of FIG. 19), a counter PC (program code) is set at program execution start position (step S92 of FIG. 19), and then scanning of the entire program is continued (step S93 of FIG. 19). The program verification and conversion mechanism 15 scans the entire program (step 93 of FIG. 19) to enable execution of the program (step S101 of FIG. 19). Then, process goes end.

The program verification and conversion mechanism 15 reads out the instruction sequence started from the position of PC (step S94 of FIG. 19). Then, check is effected whether the instruction sequence in question is the instruction sequence preliminarily determined for inhibited to use (step S95 of FIG. 19). If use inhibited, the program is inhibited execution to stop subsequent process (step 100 of FIG. 19).

On the other hand, the program verification and conversion mechanism 15 performs discrimination whether the instruction sequence in question is usable instruction sequence or not (step S96 of FIG. 19). Otherwise, the program is inhibited execution to stop subsequent process (step 100 of FIG. 19).

Subsequently, the program verification and conversion mechanism 15 discriminates whether the instruction sequence is to be object to be preliminarily re-written or not (step S97 of FIG. 19). If so, the instruction sequence is actually re-written (step S98 of FIG. 19). Finally, the counter PC is advanced for a length of the instruction sequence (step S99 of FIG. 19). The foregoing process repeats execution until scanning of the entire program.

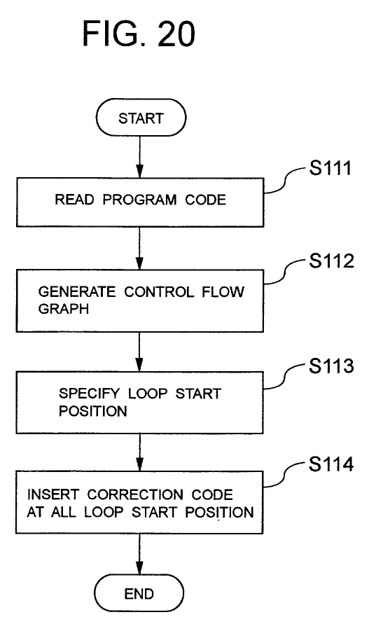

FIG. 20 is a flowchart showing operation of the program verification and conversion mechanism 15 of FIG. 3. A method for restricting calculation amount of one program will be discussed with reference to FIGS. 3 and 20.

For restricting calculation amount of the program, in addition to the foregoing process, the following program conversion which will be discussed later, will be performed. The program using CPU resource without restriction has a loop structure in the program and repeats the loop for many times. In the present invention, an instruction sequence to inspect execution period is inserted at the beginning of the loop so that when a given period is exceeded, execution of the program is stopped so as not to continue execution of respective program infinitely.

At first, the program verification and conversion mechanism 15 reads in the program code (step S111 of FIG. 20), and generates a control flow graph for the program (step S112 of FIG. 20). This can be realized by known technology. For example, A. V. Apho, R. Sesy, and J. D. Ulman, “Compiler II”, page 643, discloses such technology. Disclosure of the foregoing publication is herein incorporated by reference.

The program verification and conversion mechanism 15 specifies start position of the loop on the basis of the control flow graph (step S113 of FIG. 20). This can also be easily realized by the known technology. For example, A. V. Apho, R. Sesy, and J. D. Ulman, “Compiler II”, page 648, discloses such technology.

The program verification and conversion mechanism 15 inserts the instruction sequence for initializing parameter representative of execution period, to the beginning end of the program (step S114 of FIG. 20). Finally, at the leading end of the loop identified by step S113, an instruction sequence for stopping execution of the program is inserted when a current timing is obtained and execution period exceeds a given value (step 115 of FIG. 20).

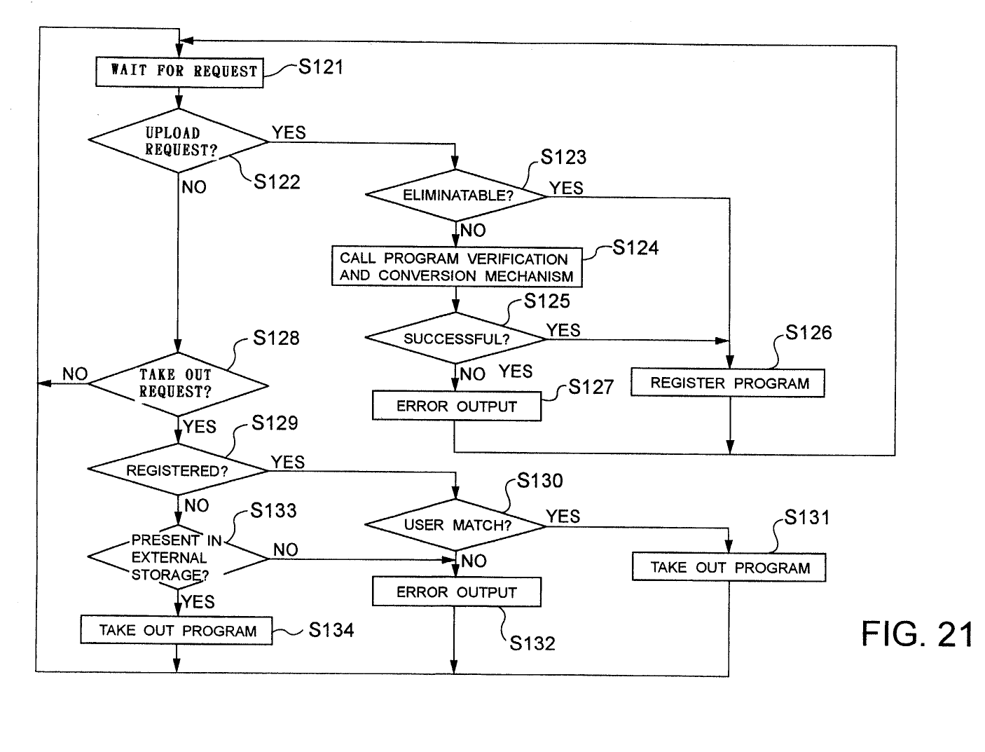

FIG. 21 is a flowchart showing operation of the program management mechanism 14 in the second embodiment of the present invention. The second embodiment of the present invention will be discussed with reference to FIG. 21. The second embodiment of the program execution service providing system according to the present invention has the same construction as the construction of the first embodiment of the program execution service providing system of FIG. 3 and only differentiated in operation. Therefore, discussion will be given hereinafter for operation.

In the first embodiment of the present invention, all of the programs uploaded by the user are verified and converted. However, it may be possible to eliminate calling of the program verification and conversion mechanism 15 when the program management mechanism 14 makes judgment that the program is secure not requiring verification by preliminary set in the program management mechanism 14, author of the program, program uploading user.

The program management mechanism 14 waits for request from both of the client communication mechanism 11 and the program execution control mechanism 16 (step S121 of FIG. 21). When the program uploading request is received from the client communication mechanism 11 (step S122 of FIG. 21), the program management mechanism 14 checks whether verification and conversion of the program can be eliminated or not (step S123 of FIG. 21). If verification and conversion of the program can be eliminated, the program is registered instantly (step S126 of FIG. 21).

Otherwise, the program management mechanism 14 calls the program verification and conversion mechanism 15 (step S124 of FIG. 21) to verify security of the program and converts the program into a format adapted for execution on the server computer 2.

When verification and conversion by the program verification and conversion mechanism 15 is successful (step S125 of FIG. 21), the program management mechanism 14 registers the program in the program table 22 together with the user ID of the user who issued the uploading request, and program names before and after conversion (step S126 of FIG. 21). In this case, if verification and conversion by the program verification and conversion mechanism 15 is not successful, the program management mechanism 14 issues error output (step S127 of FIG. 21).

On the other hand, the program management mechanism 14 is responsive to a program take out request designating the program name fed from other mechanism (S128 of FIG. 21) to check whether the program having the designated program name as the program name before conversion is registered or not (step S129 of FIG. 21). If the program having the designated program name as the program name is present in the registered program names, check is performed whether the stored user and the requested user are the same or not (step S130 of FIG. 21). If the user name and the requested name are the same, the program is taken out (step S131 of FIG. 21). If the user is not the same as the requested user, the program management mechanism 14 issues error output (step S132 of FIG. 21).

Also, when the requested program is not present in the program table 22 (not registered), the program management mechanism 14 further checks the external storage device whether the requested program name is present or not (step S133 of FIG. 21). If the program name is present in the external storage device, the corresponding program is read out (step S134 of FIG. 21). If the requested program name is not found even in the external storage device, the program management mechanism 14 issues the error output (step S132 of FIG. 21).

As set forth above, by checking whether verification and conversion of the program can be eliminated or not, it becomes possible to eliminate process cost required for verification and conversion and to execute the program operating resource which is not permitted for general programs.

Next, the third embodiment of the present invention will be discussed. The third embodiment of the program execution service providing system according to the present invention is constructed similar to the first embodiment of the program execution service providing system according to the invention shown in FIG. 3, and is only differentiated in operation. Discussion will be given for operation.

In the first embodiment of the present invention, the program is regularly executed for one execution unit by the scheduler 16a. Executing condition of each individual program has unique thread and may be executed in parallel to the scheduler 16a or the executing condition of other program.

Therefore, in the third embodiment of the present invention, the scheduler 16a does not perform execution of one execution unit but monitors occupying period of CPU of each thread to lower preferential level or to temporarily interrupt the thread and so forth if occupying period is excessively long, to lower occupation of CPU resource.

On the other hand, in the third embodiment of the present invention, regularly or when communication is performed by program, the thread is temporarily interrupted to store the executing condition of the program at that timing.

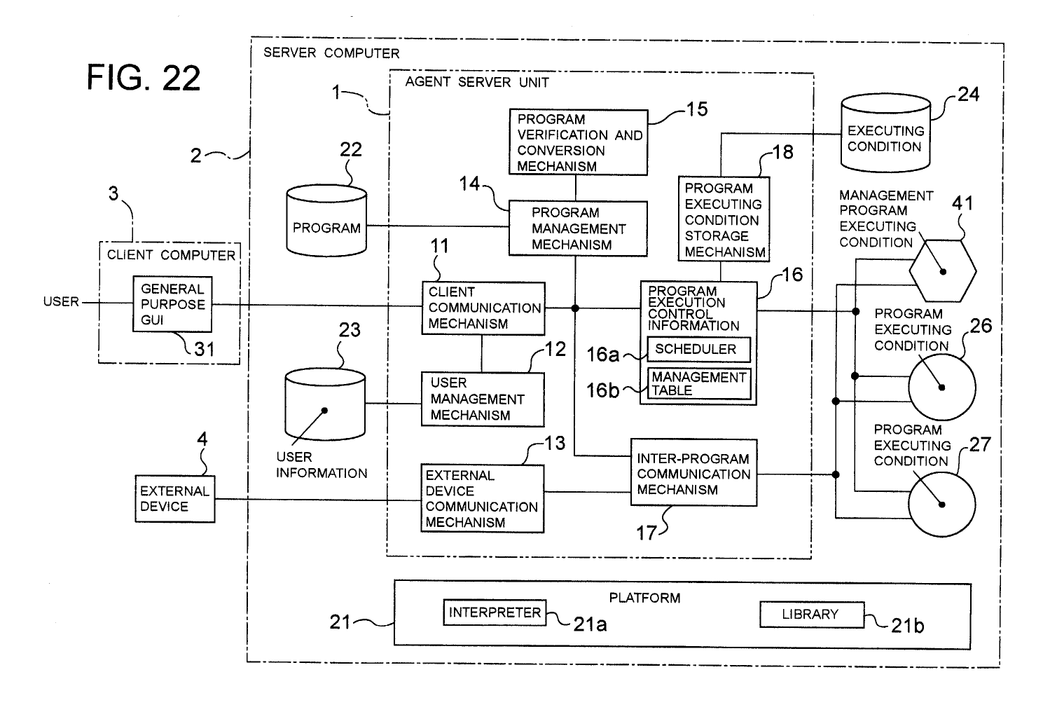

FIG. 22 is a block diagram showing a construction of the fourth embodiment of the program execution service providing system according to the present invention. In FIG. 22, the fourth embodiment of the program execution service providing system according to the present invention has the same construction as the first embodiment of the program execution service providing system according to the present invention shown in FIG. 3, except that a management program executing condition 41 is added. In the following discussion, like elements to those in the first embodiment of the present invention will be identified by like reference numerals, and operation of like elements are the same as those in the first embodiment of the present invention.

In the first embodiment of the present invention, the user directly operates the program execution control mechanism 16 in the server computer 2 via the client communication mechanism 11. By this, control operation of initiation, stop and so forth of execution of the program is performed. In the fourth embodiment of the present invention, the server management program is uploaded as the program. Then, the user performs the control operation of the program by communicating with the server management program. The management program executing condition 41 shows executing condition of the server management program.

In this case, by adding various function to the server management program, it becomes possible to realize continuously actuation or control of a plurality of programs by batch process or initiation of execution of the next program on the basis of result of execution of a plurality of programs without varying function of the control portion of the server computer 2. Furthermore, by uploading the server management program, the management function can be updated.

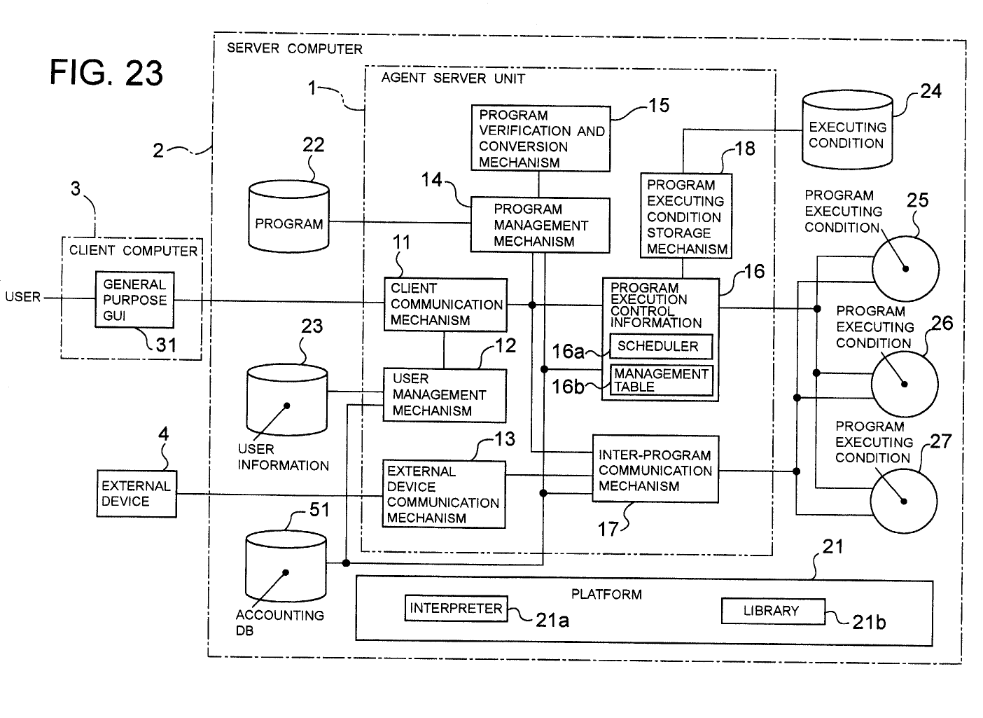

FIG. 23 is a block diagram showing a construction of the fifth embodiment of the program execution service providing system according to the present invention. In FIG. 23, the fifth embodiment of the program execution service providing system according to the present invention has similar construction as the first embodiment of the program execution service providing system according to the present invention of FIG. 3 except for adding an accounting database (DB)51. In the following discussion, like elements to those in the first embodiment of the present invention will be identified by like reference numerals, and operation of like elements are the same as those in the first embodiment of the present invention.

In the first embodiment of the present invention, no consideration has been paid with respect to use amount of various resource of the server by the user, whereas in the fifth embodiment of the present invention, an accounting database 51 is provided in the server computer 2 for recording number of class upload, number of program actuation, CPU occupying period of the actuated programs, memory use amount of the actuated programs and so forth, per user.

In the accounting database 51, information for storing accounting information used by the server computer 2 is accumulated. The program management mechanism 14 or the program execution control mechanism 16 records the imformation in the accounting database 51 as required.

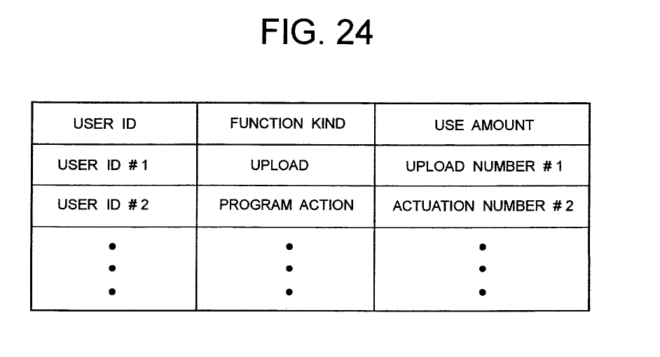

FIG. 24 is an illustration showing a data structure of the accounting database 51 of FIG. 23. In FIG. 24, in the accounting database 51, user ID, “user ID #1”, “user ID #2” of the user used the service, kind of used function “upload”, “program actuation”, and amount of function “upload number #1”, “actuation number #2” are additionally recorded sequentially as a set.

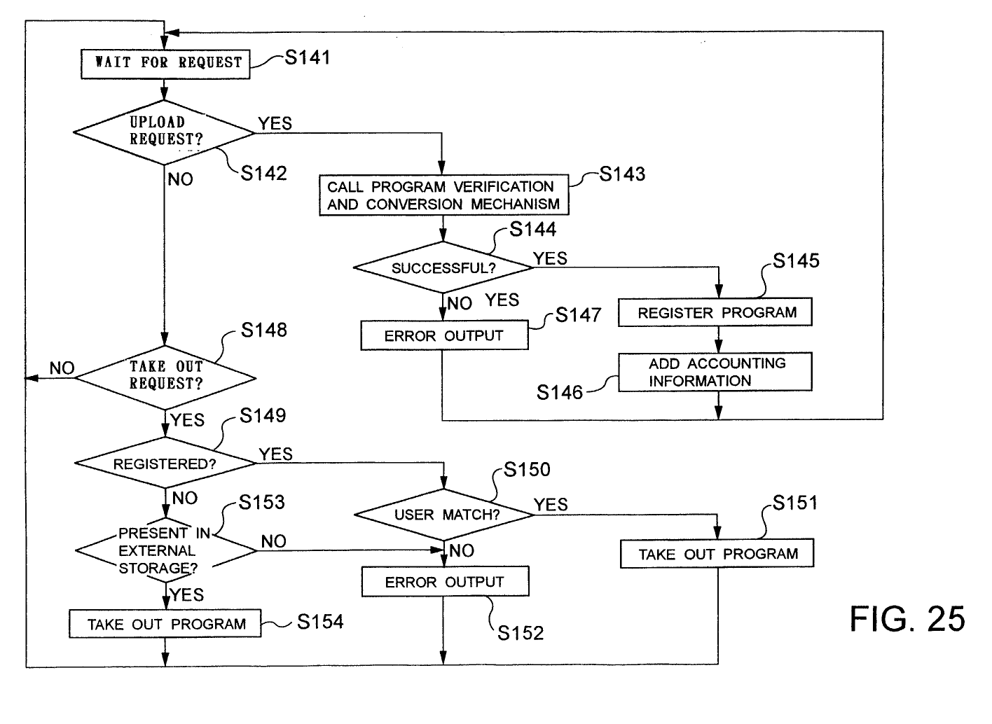

FIG. 25 is a flowchart showing operation of the program management mechanism 14 of FIG. 23. Operation of the program management mechanism 14 will be discussed with reference to FIGS. 23 to 25.

The program management mechanism 14 waits for request from both of the client communication mechanism 11 and the program execution control mechanism 16 (step S141 of FIG. 25). The program management mechanism 14 is responsive to the program upload request from the client communication mechanism 11 (step 142 of FIG. 25) and calls the program verification and conversion mechanism 15 (step S143 of FIG. 25) to verify security of the program and in conjunction therewith to convert the program into a format adapted to execution on the server computer 2.

When verification and conversion by the program verification and conversion mechanism 15 is successful (step S144 of FIG. 25), the program management mechanism 14 registers the program in the program table 22 together with the user ID of the user who issued the uploading request, and program names before and after conversion (step S145 of FIG. 25), and accounting information is added to the accounting database 51 (step S146 of FIG. 25). In this case, if verification and conversion by the program verification and conversion mechanism 15 is not successful, the program management mechanism 14 issues error output (step S147 of FIG. 25).

On the other hand, the program management mechanism 14 is responsive to a program take out request designating the program name fed from other mechanism (S148 of FIG. 25) to check whether the program having the designated program name as the program name before conversion is registered or not (step S149 of FIG. 25). If the program having the designated program name as the program name is present in the registered program names, check is performed whether the stored user and the requested user are the same or not (step S150 of FIG. 25). If the user name and the requested name are the same, the program is taken out (step S151 of FIG. 25). If the user is not the same as the requested user, the program management mechanism 14 issues error output (step S152 of FIG. 25).

Also, when the requested program is not present in the program table 22 (not registered), the program management mechanism 14 further checks the external storage device whether the requested program name is present or not in it (step S153 of FIG. 25). If the program name is present in the external storage device, the corresponding program is read out (step S154 of FIG. 25). If the requested program name is not found even in the external storage device, the program management mechanism 14 issues the error output (step S152 of FIG. 25).

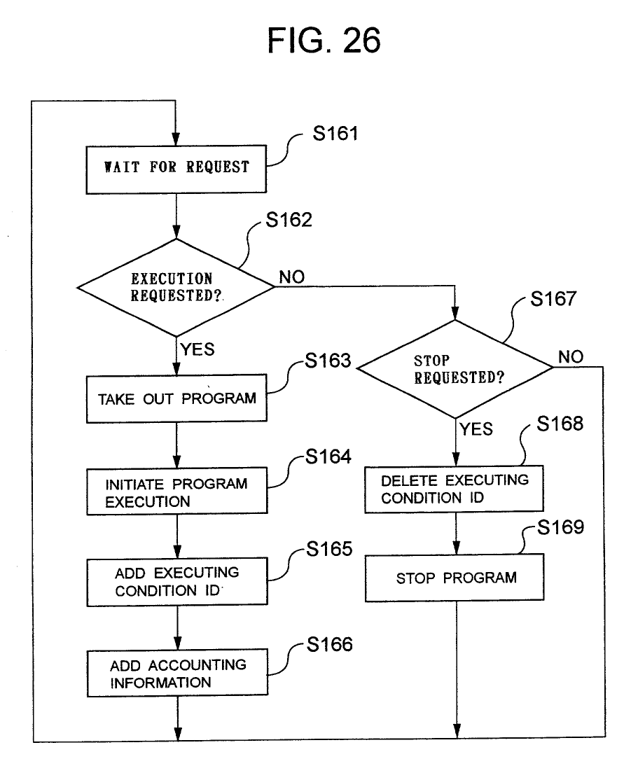

FIG. 26 is a flowchart showing operation of the program execution control mechanism 16 of FIG. 23. Operation of the program execution control mechanism 16 will be discussed with reference to FIGS. 23, 24 and 26.

The program execution control mechanism 16 waits for the request (step S161 of FIG. 26). When the program execution request is received from the client communication mechanism 11 (step S162 of FIG. 26), the designated program is read out from the program management mechanism 14 (step S163 of FIG. 26).

The program execution control mechanism 16 initiates the execution (step 164 of FIG. 26) to add the ID of the executing condition together with the ID of the user actuated the program to the management table 16b (step S165 of FIG. 26) and to add the accounting information for the accounting database 51 (step S166 of FIG. 26).

On the other hand, the program execution control mechanism 16 makes reference to the executing condition and is responsive to a program stop request (step S167 of FIG. 26) to delete information of the corresponding program ID from the management table 16b (step S168 of FIG. 26) and to stop executing condition of the designated program (step S169 of FIG. 26). The designated program is deleted from the memory and the program executing condition storage mechanism 18.

The program execution control mechanism 16 deletes the program executing condition corresponding to the program stop request only when the program stop request is explicitly received. When execution is completed by the program per se, the program is simply interrupted temporarily and is not deleted to wait for explicit request for deletion after making reference to the result of execution by the user.

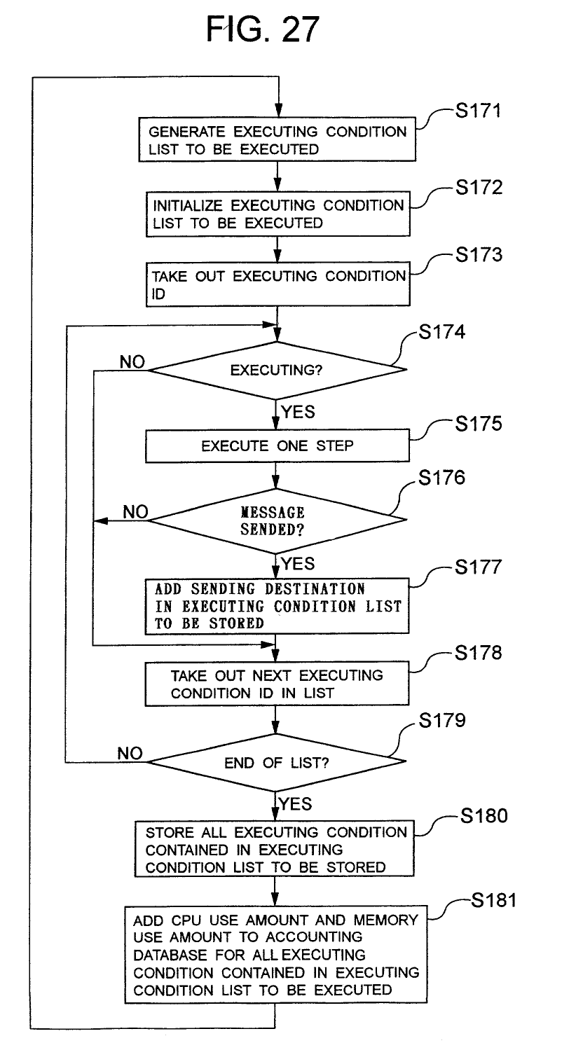

FIG. 27 is a flowchart showing operation of the scheduler 16a of FIG. 23. Operation of the scheduler 16a will be discussed with reference to FIGS. 23, 24 and 27.

At first in the turn, the scheduler 16a selects executing condition of the program to be executed within the turn among the executing condition ID of the programs registered in the management table 16b and lists those (step S171 of FIG. 27).

Next, the scheduler 16a sets a list the same as the list of executing condition to be executed as an initial value of the list of the executing condition to be stored in the final turn (step S172 of FIG. 27).

Subsequently, the scheduler 16a makes judgment whether the program executing condition is on execution or on temporarily interrupted state for all executing conditions contained in the list of the executing conditions to be executed (steps S173 and S174 of FIG. 27). If the executing condition is on execution, only one execution unit of the program may be executed (step S175 of FIG. 27). After completion of execution of one execution unit of each executing condition, respective CPU and memory use amount are stored.

When execution of one execution unit is completed, the scheduler 16a checks presence or absence of message sending on execution (step S176 of FIG. 27). When message sending is present, a sending destination executing condition ID is added to the list of the executing condition to be stored (step S177 of FIG. 27). The scheduler 16a repeats the process to the end of the list (steps S174 to S179 of FIG. 27).

Finally, the scheduler 16a transfers all executing conditions contained in the list of the executing conditions to be stored to the program executing condition storage mechanism to store simultaneously (step S180 of FIG. 27). After end of storing of the executing condition, the stored CPU and memory use amounts are added to the accounting database 51 (step S181 of FIG. 27). As a result, all of executing conditions which are executed, and all of executing conditions receiving the messages as a result of execution of the executing conditions, are stored.

A manager or administrator of the server computer 2 may check use amount of the server resource by each individual user for accounting to the user by making reference to the record on the accounting database 51, and may apply restriction of use for the user using excessive amount of server resource.

Next, the sixth embodiment of the present invention will be discussed. The sixth embodiment of the program execution service providing system according to the present invention is constructed similar to the first embodiment of the program execution service providing system according to the invention shown in FIG. 3, and is only differentiated in operation. Discussion will be given for operation.

In the first embodiment of the present invention, there is a constraint that the uploaded program can be taken out from the program management mechanism 14 only by the user who uploaded the program. However, in the sixth embodiment of the present invention, for program registration, a condition of the user who can use the program is stored in place of the registering user information to permit the user to take out the program when the user requesting taking out satisfies the condition, upon occurrence of the program taking out request.

In this case, the first embodiment of the present invention handles as special case where this condition is “requested user is equal to the uploaded user”. As an example of this condition, the requesting user belonging a particular user group, the requesting user having particular executing authority, the requesting user holding particular contract with the uploading user, and so forth are considered. By storing the conditions, it becomes possible to make the uploaded program common between a plurality of users on the basis of variety of policies.

Next, discussion will be given for the seventh embodiment of the present invention. The seventh embodiment of the program execution service providing system according to the present invention is constructed similar to the first embodiment of the program execution service providing system according to the invention shown in FIG. 3, and is only differentiated in operation. Discussion will be given for operation.

In the first embodiment of the present invention, the program to be uploaded is the program per se to be actuated, whereas, in the seventh embodiment of the present invention, the program is constructed with a plurality of components and permits uploading of a part of the components.

When the program is to be taken out, when taking out request is issued to the program management mechanism 14 with designating one component similarly to taking out normal one program, the program management mechanism 14 checks necessary other components to return those components combined into one program to the requesting user. As means for checking the necessary other components, dynamic class load function or the like supported by Java language as preferred embodiment of the present invention and so forth may be used.

By this, among the programs, by preliminarily uploading only portion having high reusability to be used frequently, and subsequently uploading only portion having low reusability to be called, a program size for uploading can be made smaller.

On the other hand, by permitting only portion of the library to be taken out by the user other than the user who uploaded the library as in the sixth embodiment of the present invention, a program realizing the user's request can be easily generated using the components prepared by other users.

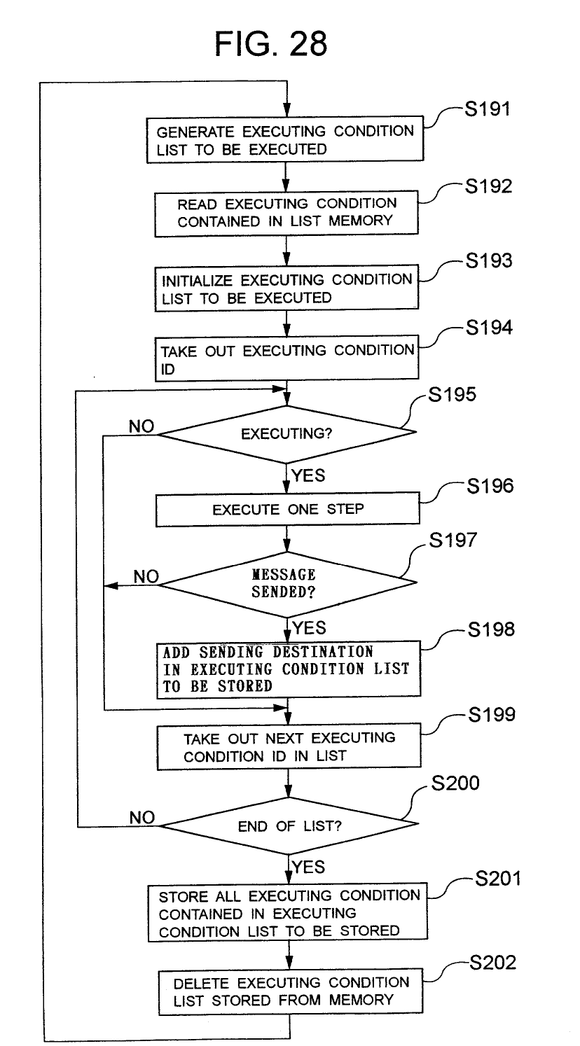

FIG. 28 is a flowchart showing operation of the eighth embodiment of the scheduler according to the present invention. Operation of the eighth embodiment of the scheduler according to the present invention will be discussed with reference to FIG. 28. The eighth embodiment of the program execution service providing system according to the present invention is constructed similar to the first embodiment of the program execution service providing system according to the invention shown in FIG. 3, and is only differentiated in operation. Discussion will be given for operation.

In the first embodiment of the present invention, the executing condition of the actuated program is stored in the database and all of the uploaded programs are all managed on the memory. In contrast to this, in the eighth embodiment of the present invention, the program executing condition which is in temporarily interrupted and is not executed instantly, is stored in the program executing condition storage mechanism 18 and is deleted from the memory. Subsequently, upon executing the program, the program executing condition is read out from the program executing condition storage mechanism 18 to the memory.

At first in the turn, the scheduler 16a selects executing condition of the program to be executed within the turn among the executing condition ID of the programs registered in the management table 16b and lists those (step S191 of FIG. 28). Then, necessary executing condition (executing condition contained in the list) is read on the memory using the program executing condition storage mechanism 18 (step S192 of FIG. 28).

Next, the scheduler 16a sets a list the same as the list of executing condition to be executed as an initial value of the list of the executing condition to be stored in the final turn (step S193 of FIG. 28).

Subsequently, the scheduler 16a makes judgment whether the program executing condition is on execution or on temporarily interrupted state for all executing conditions contained in the list of the executing conditions to be executed (steps S194 and S195 of FIG. 28). If the executing condition is on execution, only one execution unit of the program may be executed (step S196 of FIG. 28).

When execution of one execution unit is completed, the scheduler 16a checks presence or absence of message sending on execution (step S197 of FIG. 28). When message sending is present, a sending destination executing condition ID is added to the list of the executing condition to be stored (step S198 of FIG. 28). The scheduler 16a repeats the process to the end of the list (steps S195 to S200 of FIG. 28).

Finally, the scheduler 16a transfers all executing conditions contained in the list of the executing conditions to be stored to the program executing condition storage mechanism to store simultaneously (step S201 of FIG. 28). Then, the stored executing conditions are deleted from the momory. As a result, all of executing conditions which are executed, and all of executing conditions receiving the messages as a result of execution of the executing conditions, are stored.

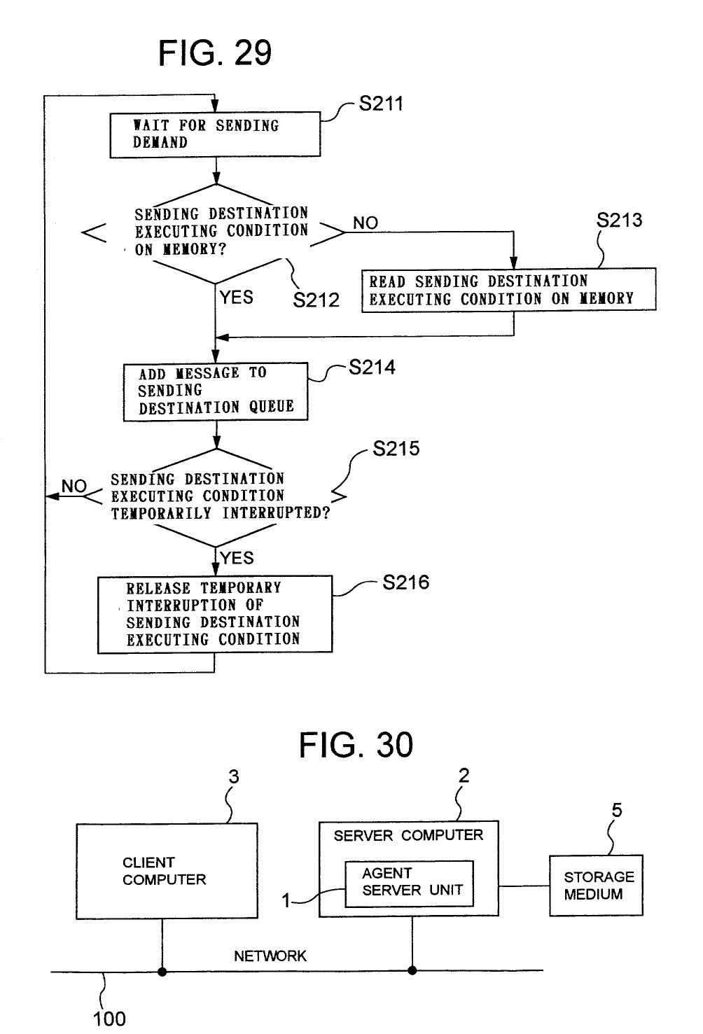

FIG. 29 is a flowchart showing operation of the inter-program communication mechanism in the eighth embodiment of the present invention. Operation of the inter-program communication mechanism of the eighth embodiment of the present invention will be discussed with reference to FIG. 29.

When the program executing condition requests sending of the message directed to other executing condition (step S211 of FIG. 29), the inter-program communication mechanism 17 checks whether the objective executing condition is present on the memory or not (step 212 of FIG. 29). If the objective executing condition is not present on the memory, the program executing condition of the sending destination is read (step S213 of FIG. 29).

The inter-program communication mechanism 17 enters the designated message to the message queue of designated other executing condition (step S214 of FIG. 29). Subsequently, the inter-program communication mechanism 17 checks whether the designated executing condition is in temporarily interrupted state or not (step S215 of FIG. 29). If the designated executing condition is in temporarily interrupted state, temporary interrupted state is released (step S216 of FIG. 29). By this. large amount of programs can be simultaneously actuated on relatively small capacity of memory.

FIG. 30 is a block diagram showing a use mode of the ninth embodiment of the agent server unit according to the present invention. In FIG. 30, both of the server computer 2 and the client computer 3 are connected to the network 100 for communication through the network 100. The agent server unit 1 operates on the server computer 2. The storage medium 5 of the agent server unit 1 is connected to the server computer 2.

On the storage medium 5, the program showing operation of the agent server unit of any of the first to eighth embodiment of the present invention set forth above may be stored. The server computer 2 reads the program of the agent server unit 1 from the storage medium 5 for execution. It should be noted that as the storage medium 5, ROM (read-only memory), an IC (integrated circuit) memory and so forth may be used.

The program uploaded on the server computer 2 is executed with conversion into a format adapted for operation on the server computer 2 after verification in view of security. Therefore, the manager or administrator of the server is not required to unnecessarily restrict or limit operation to the programs as uploaded, to increase freedom in the program of the user. Therefore, wide variety of processes desired by the user are transferred to the server computer via the general purpose user interface of the client computer 3 to execute on the server computer 2.

Since the executing condition of the program is automatically stored by the server computer 2, it becomes possible to execute not only continuous process not requiring storing of the executing condition, such as monitoring process, but also continuous process requiring storing of the executing condition, such as automatic transaction of stock.

Furthermore, by the external device communication mechanism 13 or the inter-program communication mechanism 17, cooperation with other program or process using other system other than the agent server unit 1 may also be executed.

In general, an execution parsing mechanism of the program, such as interpreter or the like requires a plurality of instruction of the program of the platform for executing one instruction of the program as execution object. Therefore, execution performance is thus lower in comparison with the case where the program is directly executed on the platform.

In the present invention, instead of parsing and executing the uploaded program by the agent server unit 1 per se, the uploaded program is taken as a part of the program of the agent server unit 1 per se by verification and conversion of the program, with maintaining security of execution and fairness of calculation resource and so forth and can be directly executed on the platform 21 to efficiently execute the uploaded program.

On the other hand, in addition that the program executing condition is automatically stored in the database or file system at an appropriate timing by the agent server unit 1, the program executing condition of the sending destination of the message sended before storing of the program executing condition is also stored simultaneously so as not to cause discrepancy of message delivery. Therefore, when the agent server unit 1 is stopped by failure during operation, execution of the program can be continued without causing discrepancy upon resumption of operation of the agent server unit 1.

Furthermore, by executing a plurality of executing conditions in a lump, and when results of execution are to be stored, storing is also performed in a lump adapted to executing condition. Thus, even when one executing condition receives messages from a plurality of executing conditions, those messages can be stored in one storing operation to efficiently store the executing conditions.

As set forth above, with the program execution service providing system according to the present invention, the program uploaded on the server is verified the security, converted into the format adapted to execution on the server to realize the system, in which the user of the service may receive service specialized for own request.

With another program execution service providing system according to the present invention, by automatically storing the executing condition of the program by the server, even when the process is continuous process requires storing of the executing condition and includes interaction with the process outside of the system and other process, the executing condition can be certainly stored without discrepancy.

With other program execution service providing system of the present invention, instead of parsing and executing the uploaded program by server per se, the uploaded program is taken as a part of the program of the agent server unit 1 per se by verification and conversion of the program, with maintaining security of execution and fairness of calculation resource and so forth and can be directly executed on the platform 21 to efficiently execute the uploaded program.

Although the present invention has been illustrated and described with respect to exemplary embodiment thereof, it should be understood by those skilled in the art that the foregoing and various other changes, omission and additions may be made therein and thereto, without departing from the spirit and scope of the present invention. Therefore, the present invention should not be understood as limited to the specific embodiment set out above but to include all possible embodiments which can be embodied within a scope encompassed and equivalent thereof with respect to the feature set out in the appended claims.

What is claimed is:

1. A program execution service providing system comprising:
a client connecting mechanism permitting a client to connect to a server via a network;
a program management mechanism individually reading any one of a program uploaded by said client and a program preliminarily prepared in said server;
a program verification and conversion mechanism verifying that the program read by said program management mechanism satisfies a nature of security not affecting for said server or other program and converting into a format adapted for execution by said server as required;
a program execution control mechanism controlling at least executing a program converted by said program verification and conversion mechanism and managing the calculation resource to be used fairly among actuated programs;
inter-program communication mechanism for mutual communication of a plurality of programs read by said program management mechanism; and
external device communication mechanism cooperating the program read by said program management mechanism and an external system of said server.

2. A program execution service providing system as set forth in claim 1, wherein said program and said server are realized at least on a byte code interpreter as a single address space and the same program.

3. A program execution service providing system as set forth in claim 1, wherein said program management mechanism includes judgment means for making judgment whether verification of security property of said program can be eliminated or not depending upon various information of the preliminarily set program upon reading of said program, and when judgment that elimination is possible, is made, verification of security property is eliminated.

4. A program execution service providing system as set forth in claim 1, said program management mechanism includes means for making judgment whether re-writing operation of the program can be eliminated or not, depending upon preliminarily set various information of the program upon reading of said program, and when judgment that elimination is possible, is made, re-writing operation is eliminated.

5. A program execution service providing system as set forth in claim 1, which further comprises program executing condition storage mechanism for storing executing condition of the actuated program in storage means at an appropriate timing during execution of the program.

6. A program execution service providing system as set forth in claim 5, wherein said program execution control mechanism guarantee simultaneous writing of executing condition of the program on sender and executing condition of the program on the sending destination of a message when message is sended from an arbitrary program executing condition to another program executing condition via said inter-program communication mechanism.

7. A program execution service providing system as set forth in claim 1, wherein said program executing control mechanism manages each executing conditions generated when one program is actuated for a plurality of times, per each actuated program with adding identification information, and
said inter-program communication mechanism enables communication between program executing conditions designated by said identification information.

8. A program execution service providing system as set forth in claim 7, wherein said client connection mechanism enables communication between said client and said executing condition of the program via said inter-program communication mechanism.

9. A program execution service providing system as set forth in claim 1, wherein said server includes a server management mechanism managing information at least including a list of programs read in the system and a list of program executing condition per executing user, and
said server can be subject to remote management from said client via said server management mechanism.

10. A program execution service providing system as set forth in claim 9, wherein said server management mechanism enables externally updating by describing as program and uploaded from said client.

11. A program execution service providing system as set forth in claim 1, which comprises an accounting database recorded by said program executing control mechanism and said program management mechanism and consisted of at least number of times of actuation, number of times of uploading, degree of use of resource of said server, and accounting is performed on the basis of accumulated content of said accounting database.

12. A program execution service providing system as set forth in claim 1, wherein said program management mechanism compares information relating to the read program an externally provided condition for enabling executing of the program and information from execution requesting user of the program, when the externally provided condition is not satisfied, execution of the program is inhibited.

13. A program execution service providing system as set forth in claim 1, wherein said program is consisted of aggregate of a plurality of execution units, each ends execution within a given period, and
said program execution control mechanism sequentially executes each one execution unit in execution of a plurality of actuated programs.

14. A program execution service providing system as set forth in claim 1, wherein said program is consisted of a plurality of components, and
said program management mechanism receives only components as a part of said program and providing as one program aggregating a plurality of components in response to read request.

15. A program execution service providing system as set forth in claim 1, wherein said program execution control mechanism comprises mechanism determining a list of executing conditions of programs to be executed at an arbitrary timing, a mechanism for executing one execution unit for all of executing conditions of the programs included in said list of the executing condition, a mechanism determining a list of executing condition to store according to results of execution of one execution units, these mechanisms are sequentially called so that when a plurality of program executing conditions contained in the list of the executing conditions of the program to be executed, send messages to one program executing condition, storing of the executing condition of the programs as sender of the messages is performed in a lump.

16. A program execution service providing system as set forth in claim 1, wherein said program execution control mechanism temporarily eliminate the executing condition of the program from the memory after writing the executing condition of said program and restores program executing condition from storage destination as required.

17. A program execution service providing system as set forth in claim 1, wherein said program verification and conversion mechanism makes verification of nature of security in the program when an instruction sequence inhibited to use is contained in the uploaded program.

18. A program execution service providing system as set forth in claim 1, wherein said program verification and conversion mechanism converts an instruction sequence into a corresponding replacement instruction sequence for use when an instruction sequence inhibited to use is contained in the uploaded program.

19. A program execution service providing system as set forth in claim 1, wherein said program verification and conversion mechanism comprises a mechanism for detecting a loop structure in said program, a mechanism for varying the program for adding a process for recording start time upon initiation of execution of the program, and a mechanism varying the program for adding process to stop execution of said program by checking an elapsed time from initiation of execution of the program for stopping execution of the program.

20. A program execution service providing system as set forth in claim 1, wherein said program verification and conversion mechanism comprises a mechanism detecting obtaining of memory in said program and a mechanism of varying the program for adding a process for checking use amount of the memory upon obtaining the memory.

21. A program execution service providing system as set forth in claim 1, wherein said program verification and conversion mechanism inhibits instruction sequence for executing any one of making reference and varying of other program executing condition in a method other than that using said inter-program communication mechanism by an arbitrary program executing condition.

22. A program execution service providing system as set forth in claim 1, which includes a flag indicative of temporary interrupt of execution in executing condition of said program,
said program execution control mechanism performing execution of the executing condition as not in temporarily interrupted state by checking said flag before execution of the program; and
said program executing condition is temporarily interrupted by varying said flag by the program.

23. A program execution service providing system as set forth in claim 22, wherein said inter-program communication mechanism checks said flag of executing condition of the sending destination upon message sending, and when the program executing condition is temporarily interrupted, temporarily interrupted state of the program executing condition is released to interrupt execution while the program wait for reception of message, and resumes execution upon reception of the message.

24. A server comprising:
a client connecting mechanism to be connected to a client via a network;
a program management mechanism individually reading any one of a program uploaded by said client and a program preliminarily prepared in said own system;
a program verification and conversion mechanism verifying that the program read by said program management mechanism satisfies a nature of security not affecting for own system or other program and converting into a format adapted for execution by said own system as required;
a program execution control mechanism controlling at least executing a program converted by said program verification and conversion mechanism and managing the calculation resource to be used fairly among actuated programs;
inter-program communication mechanism for mutual communication of a plurality of programs read by said program management mechanism; and
external device communication mechanism cooperating the program read by said program management mechanism and an external system of said own system.

25. A server as set forth in claim 24, wherein said program and said own system are realized at least on a byte code interpreter as a single address space and the same program.

26. A server as set forth in claim 24, wherein said program management mechanism includes judgment means for making judgment whether verification of security property of said program can be eliminated or note depending upon various information of the preliminarily set program upon reading of said program, and when judgment that elimination is possible, is made, verification of security property is eliminated.

27. A server as set forth in claim 24, said program management mechanism includes means for making judgment whether re-writing operation of the program can be eliminated or not, depending upon preliminarily set various information of the program upon reading of said program, and when judgment that elimination is possible, is made, re-writing operation is eliminated.

28. A server as set forth in claim 24, which further comprises program executing condition storage mechanism for storing executing condition of the actuated program in storage means at an appropriate timing during execution of the program.

29. A server as set forth in claim 28, wherein said program execution control mechanism guarantee simultaneous writing of executing condition of the program on sender and executing condition of the program on the sending destination of a message when message is sended from an arbitrary program executing condition to another program executing condition via said inter-program communication mechanism.

30. A server as set forth in claim 24, wherein said program executing control mechanism manages each executing conditions generated when one program is actuated for a plurality of times, per each actuated program with adding identification information, and
said inter-program-communication mechanism enables communication between program executing conditions designated by said identification information.

31. A server as set forth in claim 30, wherein said client connection mechanism enables communication between said client and said executing condition of the program via said inter-program communication mechanism.

32. A server as set forth in claim 24, wherein said own system includes a management mechanism managing information at least including a list of programs read in the system and a list of program executing condition per executing user, and said own system can be subject to remote management from said client via said management mechanism.

33. A server as set forth in claim 30, wherein said management mechanism enables externally updating by describing as program and uploaded from said client.

34. A server as set forth in claim 24, which comprises an accounting database recorded by said program executing control mechanism and said program management mechanism and consisted of at least number of times of actuation, number of times of uploading, degree of use of resource of said own system, and accounting is performed on the basis of accumulated content of said accounting database.

35. A server as set forth in claim 24, wherein said program management mechanism compares information relating to the read program an externally provided condition for enabling executing of the program and information from execution requesting user of the program, when the externally provided condition is not satisfied, execution of the program is inhibited.

36. A server as set forth in claim 24, wherein said program is consisted of aggregate of a plurality of execution units, each ends execution within a given period, and
said program execution control mechanism sequentially executes each one execution unit in execution of a plurality of actuated programs.

37. A server as set forth in claim 24, wherein said program is consisted of a plurality of components, and
said program management mechanism receives only components as a part of said program and providing as one program aggregating a plurality of components in response to read request.

38. A server as set forth in claim 24, wherein said program execution control a mechanism comprises mechanism determining a list of executing conditions of programs to be executed at an arbitrary timing, a mechanism for executing one execution unit for all of executing conditions of the programs included in said list of the executing condition, a mechanism determining a list of executing condition to store according to results of execution of one execution units, these mechanisms are sequentially called so that when a plurality of program executing conditions contained in the list of the executing conditions of the program to be executed, send messages to one program executing condition, storing of the executing condition of the programs as sender of the messages is performed in a lump.

39. A server as set forth in claim 24, wherein said program execution control mechanism temporarily eliminate the executing condition of the program from the memory after writing the executing condition of said program and restores program executing condition from storage destination as required.

40. A server as set forth in claim 24, wherein said program verification and conversion mechanism makes verification of nature of security in the program when an instruction sequence inhibited to use is contained in the uploaded program.

41. A server as set forth in claim 24, wherein said program verification and conversion mechanism converts an instruction sequence into a corresponding replacement instruction sequence for use when an instruction sequence inhibited to use is contained in the uploaded program.

42. A server as set forth in claim 24, wherein said program verification and conversion mechanism comprises a mechanism for detecting a loop structure in said program, a mechanism for varying the program for adding a process for recording start time upon initiation of execution of the program, and a mechanism varying the program for adding process to stop execution of said program by checking an elapsed time from initiation of execution of the program for stopping execution of the program.

43. A server as set forth in claim 24, wherein said program verification and conversion mechanism comprises a mechanism detecting obtaining of memory in said program and a mechanism of varying the program for adding a process for checking use amount of the memory upon obtaining the memory.

44. A server as set forth in claim 24, wherein said program verification and conversion mechanism inhibits instruction sequence for executing any one of making reference and varying of other program executing condition in a method other than that using said inter-program communication mechanism by an arbitrary program executing condition.

45. A server as set forth in claim 24, which includes a flag indicative of suspend of execution in executing condition of said program,
said program execution control mechanism performing execution of the executing condition as not in temporarily interrupted state by checking said flag before execution of the program; and
said program executing condition is temporarily interrupted by varying said flag by the program.

46. A server as set forth in claim 45, wherein said inter-program communication mechanism checks said flag of executing condition of the sending destination upon message sending, and when the program executing condition is temporarily interrupted, temporarily interrupted state of the program executing condition is released to interrupt execution while the program wait for reception of message, and resumes execution upon reception of the message.

47. A program execution service providing method comprising:
first step of permitting a client to connect to a server via a network;
second step of individually reading any one of a program uploaded by said client and a program preliminarily prepared in said server;
third step of verifying that the read program satisfies a nature of security not affecting for said server or other program and converting into a format adapted for execution by said server as required;
fourth step of controlling at least executing a converted program and managing the calculation resource to be used fairly among actuated programs;
fifth step of establishing mutual communication of a plurality of read programs; and
sixth step of cooperating the read program and an external system connected to said server.

48. A program execution service providing method as set forth in claim 47, wherein said program and said server are realized at least on a byte code interpreter as a single address space and the same program.

49. A program execution service providing method as set forth in claim 47, wherein said second step includes step of making judgment whether verification of security property of said program can be eliminated or not depending upon various information of the preliminarily set program upon reading of said program, and step of skipping said verification when judgment that elimination is possible, is made.

50. A program execution service providing method as set forth in claim 47, wherein said second step includes step of making judgment whether re-writing operation of the program can be eliminated or not, depending upon preliminarily set various information of the program upon reading of said program, and step of eliminating re-writing operation when judgment that elimination is possible, is made.

51. A program execution service providing method as set forth in claim 47, which further comprises seventh step of storing executing condition of the actuated program in storage means at an appropriate timing during execution of the program.

52. A program execution service providing method as set forth in claim 51, wherein said fourth step guarantee simultaneous writing of executing condition of the program on sender and executing condition of the program on the sending destination of a message when message is sended from an arbitrary program executing condition to another program executing condition.

53. A program execution service providing method as set forth in claim 47, wherein said fourth step manages each executing conditions generated when one program is actuated for a plurality of times, per each actuated program with adding identification information, and
said fifth step enables communication between program executing conditions designated by said identification information.

54. A program execution service providing method as set forth in claim 53, wherein said first step enables communication between said client and said executing condition of the program.

55. A program execution service providing method as set forth in claim 47, wherein said server includes eighth step of managing information at least including a list of programs read in the system and a list of program executing condition per executing user, and
said server can be subject to remote management from said client.

56. A program execution service providing method as set forth in claim 55, wherein said eighth step enables externally updating by describing as program and uploaded from said client.

57. A program execution service providing method as set forth in claim 47, which said second step and said fourth step record accounting information consisted of at least number of times of actuation, number of times of uploading, degree of use of resource of said server, in an accounting database, and accounting is performed on the basis of accumulated content of said accounting database.

58. A program execution service providing method as set forth in claim 47, wherein said second step compares information relating to the read program an externally provided condition for enabling executing of the program and information from execution requesting user of the program, when the externally provided condition is not satisfied, inhibits execution of the program.

59. A program execution service providing method as set forth in claim 47, wherein said program is consisted of aggregate of a plurality of execution units, each ends execution within a given period, and
said fourth step sequentially executes each one execution unit in execution of a plurality of actuated programs.

60. A program execution service providing method as set forth in claim 47, wherein said program is consisted of a plurality of components, and
said second step receives only components as a part of said program and providing as one program aggregating a plurality of components in response to read request.

61. A program execution service providing method as set forth in claim 47, wherein said fourth step comprises step of determining a list of executing conditions of programs to be executed at an arbitrary timing, step of executing one execution unit for all of executing conditions of the programs included in said list of the executing condition, step of determining a list of executing condition to store according to results of execution of one execution units, these steps are sequentially called so that when a plurality of program executing conditions contained in the list of the executing conditions of the program to be executed, send messages to one program executing condition, storing of the executing condition of the programs as sender of the messages is performed in a lump.

62. A program execution service providing method as set forth in claim 47, wherein said fourth step temporarily eliminates the executing condition of the program from the memory after writing the executing condition of said program and restores program executing condition from storage destination as required.

63. A program execution service providing method as set forth in claim 47, wherein said third step makes verification of nature of security in the program when an instruction sequence inhibited to use is contained in the uploaded program.

64. A program execution service providing method as set forth in claim 47, wherein said third step converts an instruction sequence into a corresponding replacement instruction sequence for use when an instruction sequence inhibited to use is contained in the uploaded program.

65. A program execution service providing method as set forth in claim 47, wherein said third step comprises step of detecting a loop structure in said program, step of varying the program for adding a process for recording start time upon initiation of execution of the program, and step of varying the program for adding process to stop execution of said program by checking an elapsed time from initiation of execution of the program for stopping execution of the program.

66. A program execution service providing method as set forth in claim 47, wherein said third step comprises step of detecting obtaining of memory in said program and step of varying the program for adding a process for checking use amount of the memory upon obtaining the memory.

67. A program execution service providing method as set forth in claim 47, wherein said third step inhibits instruction sequence for executing any one of making reference and varying of other program executing condition in a method other than that using said sixth step by an arbitrary program executing condition.

68. A program execution service providing method as set forth in claim 47, which said fourth step comprises step of checking a flag indicative of temporarily interrupted state of the program executing condition, and step of performing execution of the executing condition as not in temporarily interrupted state by checking said flag before execution of the program; and
said program executing condition is temporarily interrupted by varying said flag by the program.

69. A program execution service providing method as set forth in claim 68, wherein said fourth step checks said flag of executing condition of the sending destination upon message sending, and when the program executing condition is temporarily interrupted, temporarily interrupted state of the program executing condition is released to interrupt execution while the program wait for reception of message, and resumes execution upon reception of the message.

70. A storage medium storing a program making a computer to execute processes comprising:
first process of permitting a client to connect to a server via a network;
second process of individually reading any one of a program uploaded by said client and a program preliminarily prepared in said server;
third process of verifying that the read program satisfies a nature of security not affecting for said server or other program and converting into a format adapted for execution by said server as required;
fourth process of controlling at least executing a converted program and managing the calculation resource to be used fairly among actuated programs is fairly used;
fifth process of establishing mutual communication of a plurality of read programs; and
sixth process of cooperating the read program and an external system connected to said server.

71. A storage medium as set forth in claim 70, wherein said program and said server are realized at least on a byte code interpreter as a single address space and the same program.

72. A storage medium as set forth in claim 70, wherein upon making the computer to execute said second process, process of making judgment whether verification of security property of said program can be eliminated or not depending upon various information of the preliminarily set program upon reading of said program, and process of skipping said verification when judgment that elimination is possible, is made, are executed

73. A storage medium as set forth in claim 70, wherein upon making the computer to execute said second process, process of making judgment whether re-writing operation of the program can be eliminated or not, depending upon preliminarily set various information of the program upon reading of said program, and process of eliminating re-writing operation when judgment that elimination is possible, is made, are executed

74. A storage medium as set forth in claim 70, which further makes the computer to execute seventh process of storing executing condition of the actuated program in storage means at an appropriate timing during execution of the program.

75. A storage medium as set forth in claim 74, wherein upon making the computer to execute said fourth process, said fourth process guarantee simultaneous writing of executing condition of the program on sender and executing condition of the program on the sending destination of a message when message is sended from an arbitrary program executing condition to another program executing condition.

76. A storage medium as set forth in claim 70, wherein upon making the computer to execute said fourth process, said fourth process manages each executing conditions generated when one program is actuated for a plurality of times, per each actuated program with adding identification information, and
upon making the computer to execute said fifth process, said fifth process enables communication between program executing conditions designated by said identification information.

77. A storage medium as set forth in claim 76, wherein upon making the computer to execute said first process, said first process enables communication between said client and said executing condition of the program.

78. A storage medium as set forth in claim 70, which makes the computer to execute eighth process of managing information at least including a list of programs read in the system and a list of program executing condition per executing user, and
said server can be subject to remote management from said client in the eighth process.

79. A storage medium as set forth in claim 70, wherein upon making the computer to execute said second process and fourth process, said second process and said fourth process record accounting information consisted of at least number of times of actuation, number of times of uploading, degree of use of resource of said server, in an accounting database, and accounting is performed on the basis of accumulated content of said accounting database.

80. A storage medium as set forth in claim 70, wherein upon making the computer to execute said second process, said second process compares information relating to the read program an externally provided condition for enabling executing of the program and information from execution requesting user of the program, when the externally provided condition is not satisfied, inhibits execution of the program.

81. A storage medium as set forth in claim 70, wherein upon making the computer to execute said fourth process, said fourth process sequentially executes each one execution unit in execution of a plurality of actuated programs.

82. A storage medium as set forth in claim 70, wherein upon making the computer to execute said second process, said second process receives only components as a part of said program and providing as one program aggregating a plurality of components in response to read request.

83. A storage medium as set forth in claim 70, wherein upon making the computer to execute said fourth process, process of checking a flag indicative of temporarily interrupted state of the program executing condition, and process of performing execution of the executing condition as not in temporarily interrupted state by checking said flag before execution of the program and said program executing condition is temporarily interrupted by varying said flag by the program.

84. A storage medium as set forth in claim 83, wherein upon making the computer to execute said fourth process, said fourth process checks said flag of executing condition of the sending destination upon message sending, and when the program executing condition is temporarily interrupted, temporarily interrupted state of the program executing condition is released to interrupt execution while the program wait for reception of message, and resumes execution upon reception of the message.
